(19) United States
(12) Patent Application Publication
(10) Pub. No.: US 2019/0209973 A1
(43) Pub. Date: Jul. 11, 2019

(54) MULTILAYER HOLLOW FIBRE MEMBRANES

(71) Applicant: BASF SE, Ludwigshafen am Rhein (DE)

(72) Inventors: Natalia WIDJOJO, Singapore (SG); Menno BOS, Greifenberg (DE); Martin HEIJNEN, Greifenberg (DE); Peishan ZHONG, Singapore (SG); Martin WEBER, Ludwigshagfen (SG)

(73) Assignee: BASF SE, Ludwigshafen am Rhein (DE)

(21) Appl. No.: 16/328,788

(22) PCT Filed: Aug. 25, 2017
(86) PCT No.: PCT/EP2017/071417

§ 371 Date: Feb. 27, 2019

(30) Foreign Application Priority Data
Aug. 30, 2016 (EP) 16186230.5

(51) Int. Cl. B01D 65/08; B01D 61/14; B01D 69/08; B01D 71/80; B01D 71/68; B01D 69/12; B01D 71/52; B01D 71/70; C02F 1/44

(52) U.S. Cl. CPC B01D 65/08; B01D 61/145; B01D 69/08; B01D 71/80; C02F 1/444; B01D 69/12; B01D 71/52; B01D 71/70; B01D 71/68

(57) ABSTRACT

Multilayer single-bore hollow fibre membranes M or multilayer multi-bore hollow fibre membranes M for ultrafiltration applications are disclosed, comprising at least one hollow fibre membrane substrate S comprising a polymer bulk material P1 and at least one functional layer F disposed on at least the inner surface of the hollow fibre membrane substrate S, wherein the functional layer F comprises at least one polymer P2. The hollow fibre membranes may be used in ultrafiltration methods and filtration modules, in particular for the treatment of waste water.

### TECHNICAL FIELD

The present invention relates to multilayer single-bore hollow fibre membranes or multilayer multi-bore hollow fibre membranes for ultrafiltration applications, in particular for water treatment applications.

### PRIOR ART

Ultrafiltration (UF) is a membrane process which lies between microfiltration (MF) and nanofiltration (NF). The pore sizes of such membranes are typically within the range of about 2 to 100 nm. Upon applying a driving force in the range of 0.1 to 5 bar, this membrane process results in the retention of macromolecules and colloids. While these larger molecules are retained by the membrane, smaller molecules along with the solvent permeate freely. As such, the mechanism of UF depends mainly on size exclusion. This process has been widely applied in industries, such as juice and beverage, dialysis and water purification. The ideal UF membranes should have the characteristics of: (1) hydrophilicity and high water flux; (2) highly porous with sponge-like (no macrovoid) and interconnected pore structures; (3) sufficient mechanical strength with good long term membrane stability.

Most UF membranes are prepared via the phase inversion process to form asymmetric membranes from materials such as polyethersulfone (PESU), polysulfone (PSU), polyphenylenesulfone (PPSU), poly(vinylidene) fluoride (PVDF), polyacrylonitrile (PAN), cellulose acetate (CA) and polyimide based polymers (PI). Among these, polyarylsulfones are known for their chemical and mechanical resistance, thermal stability as well as ability to withstand wide ranges of temperature and corrosive environment. However, in account of the hydrophobic properties of some above-mentioned polymers, i.e. PSU and PVDF, UF membranes made from these polymers are subject to poor wettability by an aqueous media, macrovoids formation as well as fouling tendency. As a result, there is the need to include additives which commonly act as hydrophilizing and pore forming agents, i.e. polyethylene glycol (PEG), polyvinylpyrrolidone (PVP), glycerol to such polymer materials for UF applications.

According to the mechanism of biofouling, hydrophilicity or antimicrobial modification is a facile and effective method to solve the problem. The main general approaches to control biofouling in terms of material design can be divided into “anti-adhesion” approaches to reduce initial macromolecular adsorption or attachment of organisms, and “antimicrobial” approaches which attack, disperse or suppress the activity of attached organisms.

A current approach to implementing anti-fouling functionality has been to add an anti-fouling additive, for instance PESU-b-PEGMA, to the membrane material. These additives may migrate to the surface and allow for the bulk property of the PESU material to remain the same. WO 2015/075178 A1 reports on such a polymer composition comprising a blend of a bulk material and an amphiphilic polyethersulfone block copolymer and membranes being prepared thereof. However, a certain amount of the hydrophilic additive remains in the bulk material and therefore is ineffective.

A further approach is the bulk material modification, i.e. a sulfonation of polyethersulfone (PESU). This can either be established by means of a drop-in solution or a one-step spinning and allows higher packing density of the hydrophilic groups. WO2013/156598 A1 discloses ultrafiltration membranes comprising a membrane substrate layer based on a sulfonated poly(arylene ether sulfone)polymer and to a method for their preparation. However, this bulk material modification comes along with a reduction of overall mechanical strength and in higher material costs.

A still further approach to implement an anti-fouling functionality is the surface modification, for instance a coating or of the bulk material. This is considered to be rather effective since this is located only on the membrane surface but requires an additional step after membrane fabrication. On the one hand, the pore size of the material often reduces after coating and needs to be adjusted, which is quite complex, on the other hand the coating should be optimized to avoid deep penetration. This approach is reported in US 2013/0228511 A1 wherein an anti-fouling membrane is described, being formed by a hydrophobic membrane and a copolymer coated on a surface of the hydrophobic membrane as. However, for hollow fibre membranes especially the inner surface is critical with respect to bio-fouling. A simple coating of the inner surface of a hollow fibre membrane is not reported.

DE 10 2014 213 027 A1 and DE 10 2012 221 378 A1 report on processes for producing hollow fibre membranes having isoporous pore structures. The hollow fibre membranes are prepared from amphiphilic block copolymers. However, in order to prepare the membranes, large amounts of the expensive block copolymers are required.

### OBJECT OF THE INVENTION

One object of the present invention is to provide a multilayer hollow fibre membrane M, particularly for water treatment, such as multilayer single-bore hollow fibre membranes or multilayer multi-bore hollow fibre membranes, having enhanced durability, chlorine resistance and robustness of membranes.

A further object of the present invention is to prevent the multilayer single-bore hollow fibre membranes or multilayer multi-bore hollow fibre membranes from layer delamination over lifetime. A further object of the present invention is to avoid bulk material modification.

Yet another object of the present invention is to provide anti-fouling properties on the membrane surface, to create isoporous layers and to use only small amounts of high performance but expensive materials on thin layers while retaining the overall mechanical strength of fiber or multi-bore.

### SUMMARY OF THE INVENTION

According to the present invention, multilayer single-bore hollow fibre membranes M or multilayer multi-bore hollow fibre membranes M for ultrafiltration applications are provided, comprising at least one hollow fibre membrane substrate S comprising a polymer bulk material P1 and at least one functional layer F disposed on at least the inner surface of the hollow fibre membrane substrate S, wherein the functional layer F comprises at least one polymer P2.

According to the present invention, the substrate S is formed as a hollow fibre comprising at least one bore, i.e. as a single-bore or multi-bore substrate. The at least one functional layer F is applied at least to the inner surface of the substrate S. It is also feasible to apply another functional layer F′ to another surface of the substrate S, in particular to an outer surface of the substrate S. Hence, the formed membrane contains three layers, namely a substrate S and two functional layers F, F′ applied to both sides of the substrate S.

Furthermore, one or more functional layers can be applied to another functional layer F, F′ that is applied directly to the surface of the substrate S. Hence, the formed membrane contains at least two layers, namely a substrate S and a functional layer F, but may contain any number of layers, said number being greater or equal to two.

Said amphiphilic polymer P2 of said functional layer F is concentrated only in the thin layer forming the functional layer F applied to the inner and optionally to the outer surface of the substrate S, thus a higher efficiency is achieved. Since the material having the functional properties is concentrated only within the thin layer, lower material costs are an advantageous consequence.

Still further, the present invention avoids changing the properties of the polymer bulk material P1, i.e. modifications of properties of the material of which said substrate is manufactured according to the present invention. Since current approaches for anti-fouling measures come along with several advantages, i.e. anti-fouling additives remain for a certain amount of time in the bulk material or a bulk material modification leads to a general reduction of overall mechanical strength and higher material costs and a surface modification, leads to an undesired reduction of pore size after coating and adjustment processes, the present invention offers a hollow fibre membrane M which omits the disadvantages listed above coming along with current approaches for anti-fouling purposes, to give an example.

According to a further aspect of the present invention, said functionality of said at least one functional layer F is an anti-fouling function as indicated above. By assigning this functionality to said functional layer F, fouling is reduced significantly. Fouling constitutes a high-energy consumption factor for filtration. Membrane fouling results from a migration process of parts of the filtration cake into the membrane pores. A fouling process typically comes along with a pore size reduction which is very disadvantageous in particular for ultrafiltration applications, thus the present invention offers a solution to this problem here.

### BRIEF DESCRIPTION OF THE DRAWINGS

The subject-matter of the present invention is disclosed in more detail in connection with the accompanying drawings showing:

FIG. 1: A multilayer single-bore hollow fibre membrane,

FIG. 2: a multilayer multi-bore hollow fibre membrane,

FIG. 3: a rough process of fabricating a multilayer single-bore hollow fibre membrane,

FIG. 4: FESEM images of dual layer hollow fiber membranes according to Example 1 with PESU-PEO-multiblock copolymers in the inner layer of the double-layer ultra-filtration hollow fibre 1A (DL-UF-HF-PEO-1A),

FIG. 5: FESEM images of dual layer hollow fiber membranes according to Example 2 with PESU-b-PEGMA in the inner layer (DL-UF-HF-MM1-2D),

FIG. 6: FESEM images of PESU/PESU dual layer hollow fiber membranes according to Example 3 with no PVP in inner layer (DL-UF-HF-STD-1B),

FIG. 7: FESEM images of PESU/PESU dual layer hollow fiber membranes according to Example 4 with PVP in inner layer (DL-UF-HF-sPPSU-STD-1J),

FIG. 8: FESEM images of dual layer hollow fiber membranes according to Example 5 with PSU-PEO-Polysiloxane in the inner layer (DL-UF-HF-Si-1A),

FIG. 9: FESEM images of dual layer hollow fiber membranes according to Example 5 with 2.5 mol-% sulfonated polyphenylenesulfone (sPPSU) in the inner layer (DL-UF-HF-sPPSU-1C),

FIG. 10: FESEM images of dual layer hollow fiber membranes according to Example 5 with 2.5 mol-% sulfonated polyphenylenesulfone (sPPSU) in the inner layer (DL-UF-HF-sPPSU-2A).

### DETAILED DESCRIPTION OF THE INVENTION

### A. General Definitions

“Porous surface layer” refers to a polymeric surface comprising plurality of pores of same or different sizes.

“Porous separation membrane” refers to a membrane comprising a polymeric surface comprising plurality of pores of same or different sizes. “Separation” may, in particular, be understood as “filtration”. “Membranes for water treatment” are generally semi-permeable membranes which allow for separation of dissolved and suspended particles of water, wherein the separation process itself can be either pressure-driven or electrically driven.

Examples of membrane applications are pressure-driven membrane technologies such as microfiltration (MF; pore size about 0.08 to 2 μm, for separation of very small, suspended particles, colloids, bacteria), ultrafiltration (UF; pore size about 0.005 to 0.2 μm; for separation of organic particles>1000 MW, viruses, bacteria, colloids), nanofiltration (NF, pore size 0.001 to 0.01 μm, for separation of organic particles>300 MW trihalomethan (THM) precursors, viruses, bacteria, colloids, dissolved solids) or reverse osmosis (RO, pore size 0.0001 to 0.001 μm, for separation of ions, organic substances>100 MW).

“Additive” refers to a substance added in small amounts to a bulk material to modify one or more of its properties.

“Bulk material” refers to the polymer (e.g. polyethersulfone (PESU), sulfonated polyethersulfone, polysulfone (PSU), sulfonated polysulfone, polyphenylsulfone (PPSU), sulfonated polyphenylsulfone, polyacrylonitrile (PAN), polyvinylidenefluoride (PVDF), cellulose acetate (CA), polyamide (PA), polyethylene (PE), polypropylene (PP), polyester (PES), polyimide (PI), cellulose ester (CE), polytetrafluoroethylene (PTFE) and polyvinylchloride (PVC) or blends thereof) used as material for the hollow fibre membrane substrate S.

“Amphiphilic block copolymer” refers to a block copolymer characterized by a hydrophobic block unit and a hydrophilic block unit. “Block unit” refers to a building block of a polymer chain. “Hydrophilic block unit” refers to the block unit which is hydrophilic in nature and “hydrophobic block unit” to the block unit which is hydrophobic in nature.

Molecular weights of polymers are, unless otherwise stated, given as weight average molecular weight (Mw) values, in particular determined via gel permeation chromatography (GPC) in DMAc (dimethylacetamide). In particular, the GPC measurements were performed with dimethylacetamide (DMAc) containing 0.5 wt.-% lithium bromide as eluent at 80° C. Polyester copolymers were used as pre-column and column filling material. The calibration was performed with narrowly distributed PMMA standards. The flow rate was set at 1 ml/min, and the injection volume was 100 μL.

Polydispersity index (PDI) is a measure of the distribution of molecular mass in a given polymer sample. The PDI is the calculated value of weight-average molecular weight divided by the number-average molecular weight. It indicates the distribution of individual molecular masses in a batch of polymers. The PDI has a value equal to or greater than 1. As the polymer chains approach uniform chain length, the PDI approaches 1.

A “sulfonated” molecule carries at least one sulfonate (or also designated sulfo) residue of the type —SO₃H, or the corresponding metal salt form thereof of the type —SO₃⁻M⁺, like an alkali metal salt form with M=Na, K or Li

“Partially sulfonated” in the context of the present invention refers to a polymer, wherein merely a certain proportion of the monomeric constituents is sulfonated and contains at least one sulfo group residue. In particular about 0.5 to 4.5 mol.-% or about 1 to 3.5 mol.-% of the monomeric constituents or repeating units of the polymer carry at least one sulfo group. The sulfonated monomeric unit may carry one or more, as for example 2, 3, 4, in particular 2 sulfo groups. If the sulfo group content is below 0.5 mol.-% then no improvement of the hydrophilicity can be seen, if the sulfo group content is above 5 mol.-% then a membrane with macrovoids and low mechanical stability is obtained.

“Substituted” means that a radical is substituted with 1, 2 or 3, especially 1, substituent which is in particular selected from the group consisting of halogen, alkyl, OH, alkoxy, SO₃⁻, NH₂, aminoalkyl, diaminoalkyl.

“Arylene” represents bivalent, mono- or polynucleated, in particular mono-, di- or tri-nucleated aromatic ring groups which optionally may be mono- or poly-substituted, as for example mono-, di- or tri-substituted, as for example by same or different, in particular same lower alkyl, as for example C₁-C₈ or C₁-C₄ alkyl groups, and contain 6 to 20, as for example 6 to 12 ring carbon atoms. Two or more ring groups may be condensed or, more preferably non-condensed rings, or two neighboured rings may be linked via a group R selected from a C—C single bond or an ether (—O—) or an alkylene bridge, or halogenated alkylene bridge or sulfono group (—SO₂—). Arylene groups may, for example, be selected from mono-, di- and tri-nucleated aromatic ring groups, wherein, in the case of di- and tri-nucleated groups the aromatic rings are optionally condensed; if said two or three aromatic rings are not condensed, then they are linked pairwise via a C—C— single bond, —O—, or an alkylene or halogenated alkylene bridge. As examples may be mentioned: phenylenes, like hydroquinone; bisphenylenes; naphthylenes; phenanthrylenes as depicted below:

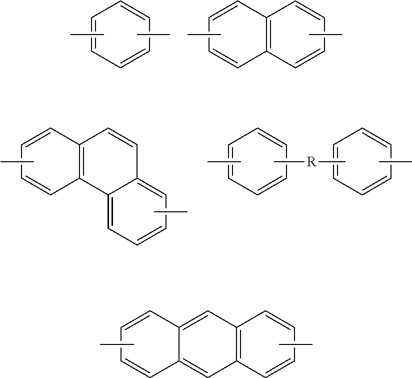

wherein

R represents a linking group as defined above like —O—, alkylene, or fluorinated or chlorinated alkylene or a chemical bond and which may be further substituted as defined above.

“Alkylene” represents a linear or branched divalent hydrocarbon group having 1 to 10 or 1 to 4 carbon atoms, as for example C₁-C₄-alkylene groups, like —CH₂—, —(CH₂)₂—, (CH₂)₃—, —(CH₂)₄—, —(CH₂)₂—CH(CH₃)—, —CH₂—CH(CH₃)—CH₂—, —(CH₂)₄—.

“Alkyl” represents a linear or branched alkyl group having 1 to 8 carbon atoms. Examples thereof are: C₁-C₄-alkyl radicals selected from methyl, ethyl, n-propyl, isopropyl, n-butyl, 2-butyl, isobutyl or tert-butyl, or C₁-C₆-alkyl radicals selected from C₁-C₄-alkyl radicals as defined above and additionally pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl.

“Perfluorinated alkyl” represents a linear or branched alkyl group having 1 to 4 carbon atoms, more preferably 1 or 2 carbon atoms, wherein all the hydrogen atoms are replaced by fluorine atoms, such as trifluoromethyl.

“Aryl” represents a 6- to 12-membered, in particular 6- to 10-membered, aromatic cyclic radical. Examples thereof are: C₆-C₁₂-aryl such as phenyl and naphthyl.

“Aryl-alkyl” represents a linear or branched alkyl group having 1 to 4 carbon atoms in particular 1 or two carbon atoms, wherein one hydrogen atom is replaced by an aryl, such as in benzyl.

“Alkoxy” represents a radical of the formula —O—, wherein R is a linear or branched alkyl group having from 1 to 6, in particular 1 to 4 carbon atoms. Examples thereof are C₁-C₆-alkoxy radicals selected from methoxy, ethoxy, n-propoxy, isopropoxy, n-butoxy, 2-butoxy, iso-butoxy (2-methylpropoxy), tert-butoxy pentyloxy, 1-methylbutoxy, 2 methylbutoxy, 3-methylbutoxy, 2,2-dimethylpropoxy, 1-ethylpropoxy, hexyloxy, 1,1-dimethylpropoxy, 1,2-dimethylpropoxy, 1-methylpentyloxy, 2-methylpentyloxy, 3-methylpentyloxy, 4-methylpentyloxy, 1,1-dimethylbutyloxy, 1,2-dimethylbutyloxy, 1,3-dimethylbutyloxy, 2,2-dimethylbutyloxy, 2,3-dimethylbutyloxy, 3,3-dimethylbutyloxy, 1-ethylbutyloxy, 2-ethylbutyloxy, 1,1,2-trimethylpropoxy, 1,2,2-trimethylpropoxy, 1-ethyl-1-methylpropoxy and 1-ethyl-2-methylpropoxy.

“Alkoxy-alkyl” represents a linear or branched alkyl group having 1 to 4 carbon atoms, more preferably 1 or 2 carbon atoms, wherein one or two hydrogen atoms are replaced by one or two alkoxy groups having 1 to 6, preferably 1 to 4, in particular 1 or 2 carbon atoms. Examples thereof are: C₁-C₆-alkoxy-C₁-C₄-alkyl radicals selected from methoxymethyl, 2-methoxyethyl, 2-methoxypropyl, 3-methoxypropyl, 2-methoxy-1-(methoxymethyl)ethyl, 2-methoxybutyl, 3-methoxybutyl, 4-methoxybutyl, ethoxymethyl, 2-ethoxyethyl, 2-ethoxypropyl, 3-ethoxypropyl, 2-ethoxy-1-(ethoxymethyl)ethyl, 2-ethoxybutyl, 3-ethoxybutyl, 4-ethoxybutyl.

“Heterocyclyl” represents a 3- to 12-membered heterocyclic radical including a saturated heterocyclic radical, an unsaturated non-aromatic heterocyclic radical, and a heteroaromatic radical (hetaryl), which generally have 3, 4, 5, 6 or 7 ring forming atoms. The heterocyclic radicals may be bound via a carbon atom (C-bound) or a nitrogen atom (N-bound). The heterocyclic radicals comprise 1, 2, or 3 heteroatoms selected from N, O, and S. “N-heterocycle” comprises 1, 2, or 3 N-heteroatoms. Examples thereof are: C₃-C₁₂-heterocyclyl selected from pyridyl, furanyl, thienyl, N-pyrrolidinyl, indolyl.

“Halogen” represents F, Cl, Br, I, and in particular F or Cl, preferably Cl.

### B. Particular Embodiments

According to the present invention, multilayer single-bore hollow fibre membranes M or multilayer multi-bore hollow fibre membranes M for ultrafiltration applications are provided, comprising at least one hollow fibre membrane substrate S comprising a polymer bulk material P1 and at least one functional layer F disposed on at least the inner surface of the hollow fibre membrane substrate S, wherein the functional layer F comprises at least one polymer P2.

In the following, particular embodiments for each component and the entire hollow fibre membranes M according to the invention are described.

### Particular Embodiments for the Substrate S

According to one embodiment of the present invention, the substrate S comprises a polymeric bulk material P1 which is appropriate to form hollow fibre membranes M comprising a sponge-like, macrovoid-free substrate layer.

The substrate S may essentially consist of the polymeric bulk material P1. This means that the polymeric bulk material P1 constitutes ≥97% by weight, preferably ≥98% by weight, in particular ≥99% by weight of the material of the substrate S. However, in a preferred embodiment, the substrate may further comprise additives, in particular polymers, which are used to facilitate the pore formation during the preparation of the membrane. These additives may be present in the substrate S of the final hollow fibre membrane M in an amount of up to 10% by weight of the entire material of the substrate S (e.g. based on the weight of the substrate (S)), in particular in an amount of 0.2 to 5% by weight, such as 0.3 to 2% by weight. Suitable additives are pore forming agents such as polyethylene glycol (PEG) and polyvinylpyrrolidone (PVP).

According to one embodiment of the present invention the polymer bulk material P1 is not particularly limited. Suitable polymeric materials P1 may be selected from the group consisting of polyethersulfone (PESU), sulfonated polyethersulfone, polysulfone (PSU), sulfonated polysulfone, polyphenylsulfone (PPSU), sulfonated polyphenylsulfone, polyacrylonitrile (PAN), polyvinylidenefluoride (PVDF), cellulose acetate (CA), polyamide (PA), polyethylene (PE), polypropylene (PP), polyester (PES), polyimide (PI), cellulose esters (CE), polytetrafluoroethylene (PTFE), polyvinylchloride (PVC) or blends thereof.

In a preferred embodiment, the polymer bulk material P1 essentially consists of one of the materials selected from the group consisting of polyethersulfone (PESU), sulfonated polyethersulfone, polysulfone (PSU), sulfonated polysulfone, polyphenylsulfone (PPSU), sulfonated polyphenylsulfone, polyacrylonitrile (PAN), polyvinylidenefluoride (PVDF), cellulose acetate (CA), polyamide (PA), polyethylene (PE), polypropylene (PP), polyester (PES).

In another preferred embodiment of the present invention, the bulk material P1 is selected from the group consisting of polyethersulfone (PESU), sulfonated polyethersulfone, polysulfone (PSU), sulfonated polysulfone, polyphenylsulfone (PPSU), and sulfonated polyphenylsulfone. From the viewpoint of stability of the substrate and compatibility of the substrate material P1 with the functionalized material P2, polyethersulfone (PESU) is particularly preferred as the bulk material P1.

Molecular weights of the bulk material P1 are preferably in a range of Mw=10,000 g/mol to 500,000 g/mol, more preferably Mw=20,000 g/mol to 250,000 g/mol, in particular Mw=50,000 g/mol to 150,000 g/mol.

The hollow fibre membrane substrate S has a tubular shape. In particular, the hollow fibre membrane substrate S preferably has an inner bore diameter of from 0.1 to 5 mm, in particular of from 0.5 to 3 mm and an outer diameter of from 0.5 to 10 mm, in particular 1 to 5 mm. The thickness of the wall of the hollow fibre membrane substrate S is on average between 0.1 and 3 mm, in particular between 0.2 and 0.5 mm. From the viewpoint of increased permeability of the membrane, a thin membrane wall is preferred.

### Particular Embodiments for the Functional Layer F

The functional layer F is applied to at least the inner surface of the hollow fibre membrane substrate S comprising the bulk material P1. According to the present invention, said the material of said functional layer F (i.e. the material which constitutes the functional layer F) includes at least one polymer P2, whereas said material of said substrate S (i.e. the material which constitutes the substrate S) includes at least one bulk material polymer P1, said polymers P1 and P2 being different with respect to each other. The additional functional layer on at least the inner surface of the substrate has the advantage of providing anti-fouling properties as well as of a pore size control. Delamination of the functional layer F is therefore prevented.

In one embodiment, the functional layer F consists of the at least one amphiphilic polymer P2, i.e. the content of the at least one amphiphilic polymer P2 is 100 wt.-% based on the total weight of the material of the functional layer F.

However, in addition to the at least one polymeric material P2, the functional layer F may also comprise one or more polymeric bulk materials P1. The polymeric bulk material P1 contained in the functional layer F may be the same polymeric bulk material P1 contained in the hollow fibre substrate S. However, the polymeric bulk material P1 contained in the functional layer F may also be different from the polymeric bulk material P1 contained in the hollow fibre substrate S. In a preferred embodiment, the polymeric bulk material P1 contained in the functional layer F and the polymeric bulk material P1 contained in the hollow fibre substrate S are identical.

In a further embodiment, the functional layer F may comprise a blend of at least one polymeric bulk material P1 and at least one amphiphilic polymer P2 wherein the ratio of P1:P2 may vary from 80 wt.-%:20 wt.-% to 0.1 wt.-%:99 wt.-%, preferably from 60 wt.-%:40 wt.-% to 5 wt.-%:95 wt.-%, in particular from 20 wt.-%:80 wt.-% to 10 wt.-%:90 wt.-%, based on the total weight of the material of the functional layer F.

In a further preferred embodiment, the functional layer F may further comprise additives, in particular polymers, which are used to facilitate the pore formation during the preparation of the membrane. These additives may be present in the functional layer F of the final hollow fibre membrane M in an amount of up to 10% by weight of the material of the functional layer F, in particular in an amount of 0.2 to 5% by weight, such as 0.3 to 2% by weight. Suitable additives are pore forming agents such as polyethylene glycol (PEG) and polyvinylpyrrolidone (PVP).

The functional layer F is applied in form of a thin layer to at least the inner surface of the hollow fibre membrane substrate S comprising the bulk material P1. Thus, the functional layer F has a thickness of only 1 to 20%, in particular 5 to 15%, of the thickness of the hollow fibre membrane substrate to which the functional layer F is applied. For example the functional layer F has a thickness of from 5 to 600 μm, like 10 to 450 μm, in particular from 15 to 100 μm, like 15 to 50 μm and is applied to the inner surface of the tubular hollow fibre membrane substrate S. This reduces the required amount of the amphiphilic polymer P2 without having disadvantageous effects on the membrane properties.

Specifically, the amphiphilic polymer P2 may be selected from the group consisting of the following amphiphilic block copolymers P2.1, P2.2, P2.3, P2.4 and P2.5, wherein
P2.1 is an amphiphilic polyethersulfone block copolymer comprising at least one, like 1, 2, 3 or 4, in particular 1, hydrophobic block unit (A) and at least one, like 1, 2, 3, 4 or 5, in particular 1 or 2, hydrophilic block unit (B) of the following general formulae:

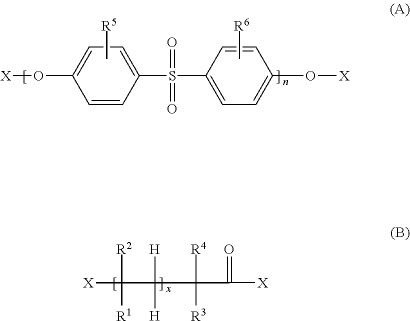

wherein

R¹ is —CO(O-alkylene)ₘ—OR⁷, —CO(O-alkylene)ₘ—SO₃⁻M⁺, —CO(O-alkylene)ₘ—NR⁸R⁹R¹⁰, —CO—Z—N—R⁸R⁹, —CO(O-alkylene)ₘ—NHR⁸, —CO(O-alkylene)ₘ—N⁺R⁸R⁹R¹¹W⁻, or optionally substituted N-heterocyclyl (e.g. N-pyrrolidonyl);

R² is hydrogen, halogen, optionally substituted alkyl (e.g. methyl), perfluorinated alkyl, optionally substituted aryl, cyano, nitro, amino, or heterocyclyl;

R³, R⁴ independently are hydrogen, halogen, optionally substituted alkyl (e.g. methyl), perfluorinated alkyl, optionally substituted aryl, cyano, nitro, amino, or heterocyclyl;

R⁵, R⁶ independently are hydrogen, halogen, or a sulfonic acid group;

n is an integer in a range from 5 to 80, 20 to 70 or 40 to 50;

m, x independently are integer in a range from 1 to 20, 2 to 15 or 5 to 10;

R⁷ is hydrogen, alkyl, or alkoxy-alkyl (e.g. 2-methoxy-ethyl);

R⁸, R⁹ independently are hydrogen, optionally substituted alkyl (e.g. Me, tBu);

R¹⁰ is alkylene-SO₃H or alkylene-SO₃⁻M⁺ (e.g. —(CH₂)₃SO₃⁻M⁺);

R¹¹ is hydrogen, alkyl, aryl-alkyl;

Z is alkylene or a chemical bond;

X is hydrogen or another block unit (B) in which X, x, and R¹ to R⁴ are as defined above;

W is halogen, OTf, BF₄, BPh, PF₆ or SbF₆;

M is alkaline metal (Na, K, Li) or alkaline earth metal (e.g. Ca, Mg);
P2.2 is an amphiphilic partially sulfonated poly(arylene ether sulfone) block copolymer comprising at least one, like 1, 2, 3 or 4, in particular 1, block unit (C) and at least one, like 1, 2, 3, 4 or 5, in particular 1 or 2, block unit (D) of the following general formulae:

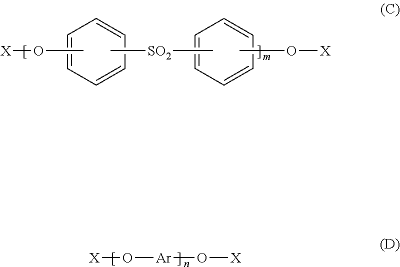

wherein

Ar represents a divalent arylene residue;

m, n are independently integer in a range from 1 to 80, 1 to 50 or 1 to 20;

X each independently represents a hydrogen atom, an alkyl group, a block unit (C) or a block unit (D);

at least one monomeric block unit selected from (C) and (D) is sulfonated;

and

wherein the aromatic rings of (C) and/or (D) may further carry one or more same or different substituents (different from sulfo residues of the type —SO₃H, or the corresponding metal salt form thereof of the type —SO₃⁻M⁺), in particular those suitable for improving the feature profile (like mechanical strength, or permeability) of said substrate layer. Suitable substituents may be alkyl substituents having 1 to 6 carbon atoms, like methyl or ethyl.
P2.3 is an amphiphilic polystyrene block copolymer comprising at least one, like 1, 2, 3 or 4, in particular 1, hydrophobic block unit (E) and at least one, like 1, 2, 3, 4 or 5, in particular 1 or 2, hydrophilic block unit (F) of the following general formulae:

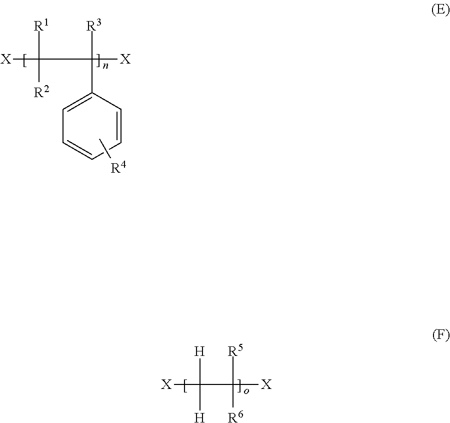

wherein

R¹, R² independently are hydrogen, halogen, optionally substituted alkyl (e.g. methyl), perfluorinated alkyl, optionally substituted aryl, cyano, nitro, amino, or heterocyclyl;

R³ is hydrogen, an optionally substituted alkyl having 1 to 18 carbon atoms or an aryl, optionally substituted with 1 to 5, preferably 1 or 2 substituents selected from a hydrogen, halogen or a sulfonic acid group;

R⁴ is hydrogen, halogen or a sulfonic acid group;

R⁵ is —CO(O-alkylene)ₘ—OR⁷, —CO(O-alkylene)ₘ—SO₃⁻M⁺, —CO(O-alkylene)ₘ—NR⁸R⁹R¹⁰, —CO(O-alkylene)ₘ—NHR⁸, —CO(O-alkylene)ₘ—N⁺R⁸R⁹R¹¹W⁻;

R⁶ is hydrogen, an optionally substituted alkyl having 1 to 18 carbon atoms or an aryl, optionally substituted with 1 to 5, preferably 1 or 2 substituent selected from a hydrogen, halogen or a sulfonic acid group;

X each independently represents a hydrogen atom, an alkyl group, a block unit (E) or a block unit (F);

n, o independently are integer in a range from 20 to 80, 30 to 70 or 40 to 50;

m is an integer in a range from 1 to 20, 2 to 15 or 5 to 10;

R⁷ is hydrogen, alkyl, or alkoxy-alkyl (e.g. 2-methoxy-ethyl);

R⁸, R⁹ independently are hydrogen, optionally substituted alkyl (e.g. Me, tBu);

R¹⁰ is alkylene-SO₃H or alkylene-SO₃⁻M⁺ (e.g. —(CH₂)₃SO₃⁻M⁺);

R¹¹ is hydrogen, alkyl, aryl-alkyl;

W is halogen, OTf, BF₄, BPh, PF₆ or SbF₆;

M is alkaline metal (Na, K, Li) or alkaline earth metal (e.g. Ca, Mg);
P2.4 is an amphiphilic polystyrene block-copolymer comprising at least one, like 1, 2, 3 or 4, in particular 1, hydrophobic block unit (G) and at least one, like 1, 2, 3, 4 or 5, in particular 1 or 2, hydrophilic block unit (H) of the following general formulae:

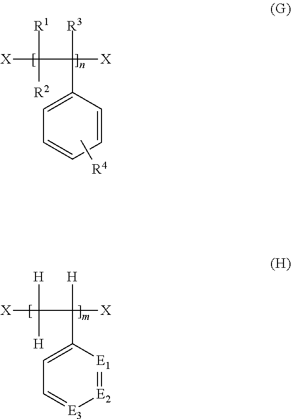

wherein

R¹, R² independently are hydrogen, halogen, optionally substituted alkyl (e.g. methyl), perfluorinated alkyl, optionally substituted aryl, cyano, nitro, amino, or heterocyclyl;

R³ is hydrogen, an optionally substituted alkyl having 1 to 18 carbon atoms or an aryl, optionally substituted with 1 to 5, preferably 1 or 2 substituent selected from a hydrogen, halogen or a sulfonic acid group;

R⁴ is hydrogen, halogen or a sulfonic acid group;

X each independently represents a hydrogen atom, an alkyl group, a block unit (G) or a block unit (H);

n, m independently are integer in a range from 20 to 80, 30 to 70 or 40 to 50; and

E¹, E², and E³ represent a carbon atom or a nitrogen atom, with the proviso that if one of E¹, E², or E³ represents a nitrogen atom, the other two represent a carbon atom;

and
P2.5 is an amphiphilic poly(arylene ether sulfone) block copolymer comprising at least one, like 1, 2, 3 or 4, in particular 1, hydrophilic block unit (I) and at least one, like 1, 2, 3, 4 or 5, in particular 1 or 2, hydrophobic block unit (J) of the following general formulae:

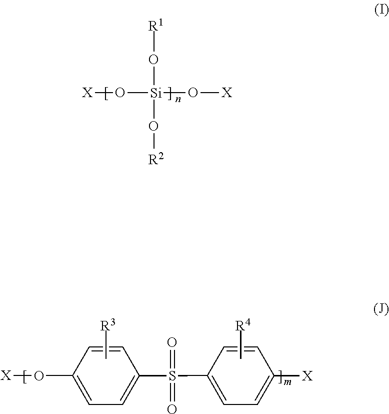

wherein

R¹, R² independently are linear, branched or cyclic alkyls having 1 to 18 carbon atoms, a further block unit (I) or a block unit (J);

R⁵, R⁶ independently are hydrogen, halogen, or a sulfonic acid group;

X each independently represents a hydrogen atom, an alkyl group, a repeating unit (I) or a repeating unit (J);

n is an integer in a range from 1 to 10,

m is an integer in a range from 5 to 80, 20 to 70 or 40 to 50.

In the following, particularly preferred embodiments for each of the polymeric materials P2.1, P2.2, P2.3, P2.4 and P2.5 are given.

### Specific Embodiments for Polymeric Material P2.1

According to one embodiment of the present invention, the functional layer F of the hollow fibre membrane M comprises a polymeric material P2.1, which is an amphiphilic polyethersulfone block copolymer comprising at least one hydrophobic block unit (A) and at least one hydrophilic block unit (B) as defined above.

In one embodiment, the amphiphilic polymer P2 preferably essentially consists of the amphiphilic polyethersulfone P2.1. This means that the amphiphilic polystyrene block copolymer P2.1 constitutes ≥97% by weight, preferably ≥98% by weight, in particular ≥99% by weight of the material of the amphiphilic polymer P2.

In connection with the above described block units (A) and (B), an R¹ substituted N-heterocyclyl is preferably an N-heterocyclyl wherein two substituents form with the carbon atom to which they are attached a carbonyl, such as in N-pyrrolidon-2-yl.

In connection with R², R³, R⁴, R⁵, R⁶, R⁸ and R⁹, substituted alkyl is preferably C₁-C₄-alkyl substituted with halogen, alkyl, OH, alkoxy, like C₁-C₄-alkoxy, SO₃H, NH₂, aminoalkyl, diaminoalkyl, like amino C₁-C₄-alkyl, diamino C₁-C₄-alkyl.

In connection with R², R³, R⁴, R⁵, R⁶, R⁸ and R⁹, substituted aryl is preferably C₆-C₁₂-aryl substituted with halogen, alkyl, like C₁-C₄-alkyl, OH, alkoxy, like C₁-C₄-alkoxy, SO₃H, NH₂, aminoalkyl, diaminoalkyl, like amino C₁-C₄-alkyl, diamino C₁-C₄-alkyl.

R¹ is preferably —CO(O-alkylene)ₘ—OR⁷, —CO(O-alkylene)ₘ—SO₃⁻M⁺, —CO(O-alkylene)ₘ—NHR⁸, —CO(O-alkylene)ₘ—N⁺R⁸R⁹R¹¹W⁻, —CO(O-alkylene)ₘ—NR⁸R⁹R¹⁰, or N-pyrrolidonyl. Alkylene is in particular C₂-C₄ alkylene. In particular, R¹ is —CO(O—(CH₂)₂)₂)ₘ—OR⁷, —CO(O—(CH₂)₃)ₘ—SO₃⁻M⁺, —CO(O—(CH₂)₂)₂)ₘ—N⁺R⁸R⁹R¹¹W⁻, —CO(O—(CH₂)₂)ₘ—NR⁸R⁹R¹⁰, or N-pyrrolidonyl.

R² is preferably hydrogen or alkyl, like C₁-C₄-alkyl (e.g. methyl). In particular, R² is hydrogen or methyl.

Preferably, R³ and R⁴ independently are hydrogen or alkyl, like C₁-C₄-alkyl (e.g. methyl); in particular, R³ and R⁴ are methyl.

Preferably, R⁵ and R⁶ independently are hydrogen or alkyl, like C₁-C₄-alkyl (e.g. methyl); in particular, R⁵ and R⁶ are hydrogen.

R⁷ is preferably hydrogen or alkoxy-alkyl (e.g. 2-methoxy-ethyl); in particular, R⁷ is hydrogen or 2-methoxy-ethyl.

Preferably, R⁸ and R⁹ independently are hydrogen or alkyl, like C₁-C₄-alkyl (e.g. Me, tBu). In particular, R⁸ and R⁹ independently are hydrogen, methyl, or tert-butyl.

R¹⁰ is preferably C₂-C₄ alkylene-SO₃H (e.g. —(CH₂)₃SO₃H) or alkylene-SO₃⁻M⁺ (e.g. —(CH₂)₃SO₃ M⁺); in particular, R¹⁰ is —(CH₂)₃SO₃H.

R¹¹ is preferably hydrogen.

M is preferably an alkaline metal (e.g. K).

W is preferably halogen, like Cl or F.

According to one embodiment, the amphiphilic polyethersulfone block copolymer P2.1 comprising at least one hydrophobic block unit (A) and at least one hydrophilic block unit (B) has the structure B-A or B-A-B.

According to a preferred embodiment, the structure of the amphiphilic polyethersulfone block copolymer P2.1 is B-A-B.

According to another embodiment, the functional polymer P2 is an amphiphilic polyethersulfone block copolymer P2.1 comprising at least one hydrophilic unit (B) in an amount in the range of 1 to 90 wt.-% and in particular 8 to 80 wt.-% per total weight of the dried block copolymer P2.1.

According to another embodiment, the amphiphilic polyethersulfone block copolymer (P2) comprises a hydrophobic block unit (A) and a hydrophilic block unit (B) has the general formula (I)

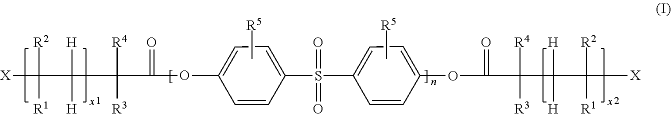

wherein x¹ and x² independently have the meaning of x and X, R¹, R², R³, R⁴, R⁵, R⁶, n and x are as defined above.

According to a preferred embodiment, the amphiphilic polyethersulfone block copolymer P2.1 is represented by the general formula (I) wherein

R¹ is —CO(O-alkylene)ₘ—OR⁷, —CO(O-alkylene)ₘ—SO₃⁻M⁺, —CO(O-alkylene)ₘ—NR⁸R⁹R¹⁰, —CO(O-alkylene)ₘ—NHR⁸, —CO(O-alkylene)ₘ—N⁺R⁸R⁹R¹¹W⁻, or N-pyrrolidonyl;

R² is hydrogen or alkyl (e.g. Me);

R³, R⁴ independently are alkyl (e.g. Me);

R⁵, R⁶ are hydrogen;

n is an integer in a range from 5 to 80, 20 to 70 or 40 to 50;

m, x¹, x² independently are integers in a range from 1 to 20, 2 to 15 or 5 to 10;

R⁷ is hydrogen or alkoxy-alkyl (e.g. 2-methoxy-ethyl);

R⁸, R⁹ independently are hydrogen or alkyl (e.g. Me, tBu);

R¹⁰ is alkylene-SO₃H or alkylene-SO₃⁻M⁺ (e.g. —(CH₂)₃SO₃H);

R¹¹ is hydrogen, alkyl, like methyl or ethyl, or aryl-alkyl, like phenylmethyl;

W is halogen, OTf, BF₄, BPh, PF₆ or SbF₆, in particular halogen, like F or Cl;

X is halogen or hydrogen;

M is alkaline metal (e.g. Na, K, Li) or alkaline earth metal (e.g. Ca, Mg).

According to a further preferred embodiment, the functional polymer is an amphiphilic polyethersulfone block copolymer P2.1 of the general formula (I) wherein

R¹ is —CO(O—(CH₂)₂)ₘ—OR⁷, —CO(O—(CH₂)₃)ₘ—SO₃⁻M⁺, —CO(O—(CH₂)₂)ₘ—NR⁸R⁹R¹⁰, —CO(O-alkylene)ₘ—NHR⁸, —CO(O-alkylene)ₘ—N⁺R⁸R⁹R¹¹W⁻, or N-pyrrolidonyl;

R² is hydrogen or methyl;

R³, R⁴ are methyl;

R⁵, R⁶ are hydrogen;

n is an integer in a range from 5 to 80, 20 to 70 or 40 to 50;

m, x¹, x² independently are integers in a range from 1 to 20; 1 to 20, 2 to 15 or 5 to 10;

R⁷ is hydrogen or 2-methoxy-ethyl;

R⁸, R⁹ independently are hydrogen, methyl, or tert-butyl;

R¹⁰ is —(CH₂)₃SO₃H;

R¹¹ is hydrogen, methyl, ethyl, or phenylmethyl;

W is halogen, like F or Cl;

X is hydrogen or bromine;

M is an alkaline metal (e.g. K).

Examples of amphiphilic polyethersulfone block copolymers P2.1 of the general formula (I) may include but are not limited to:

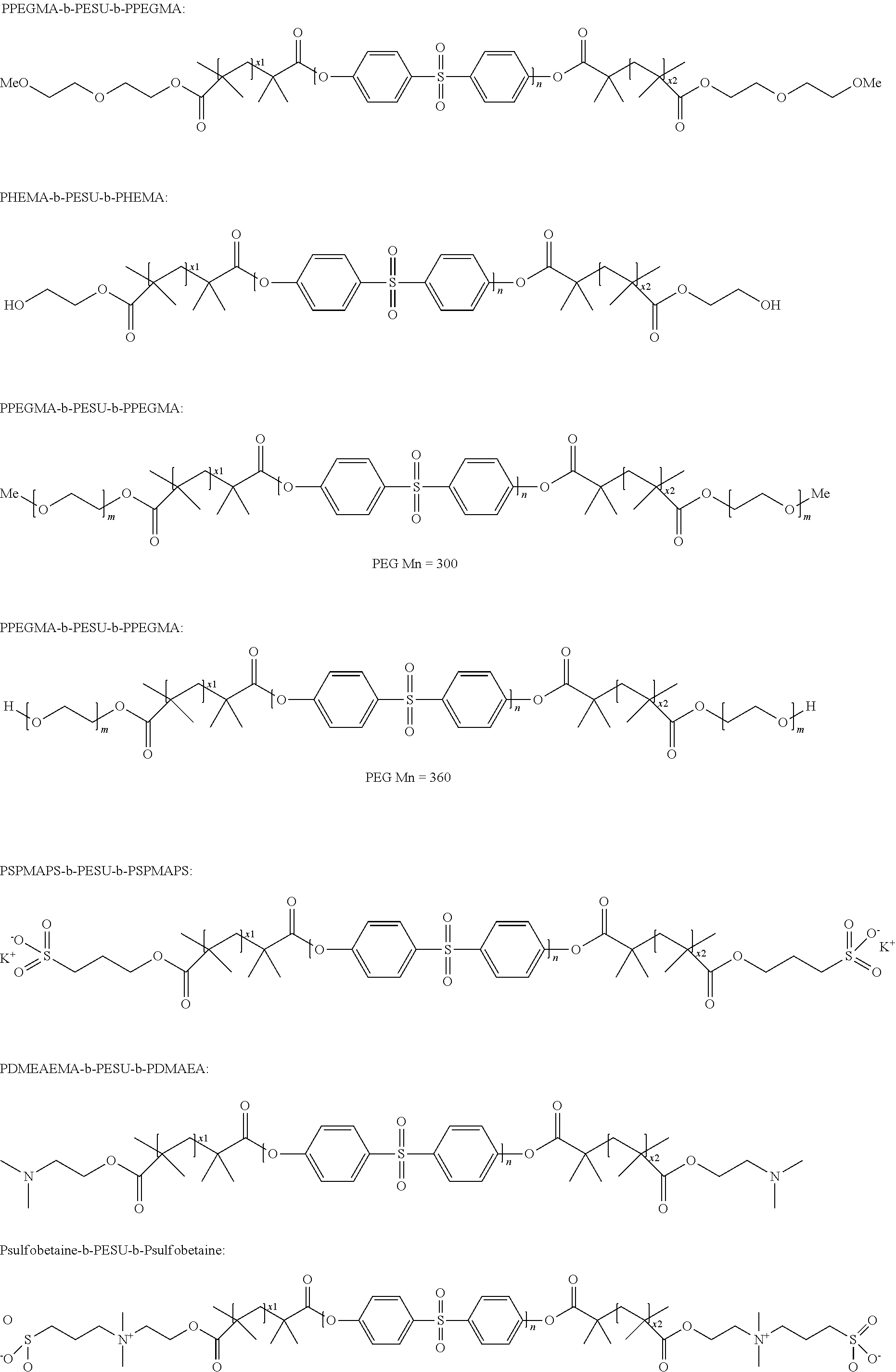

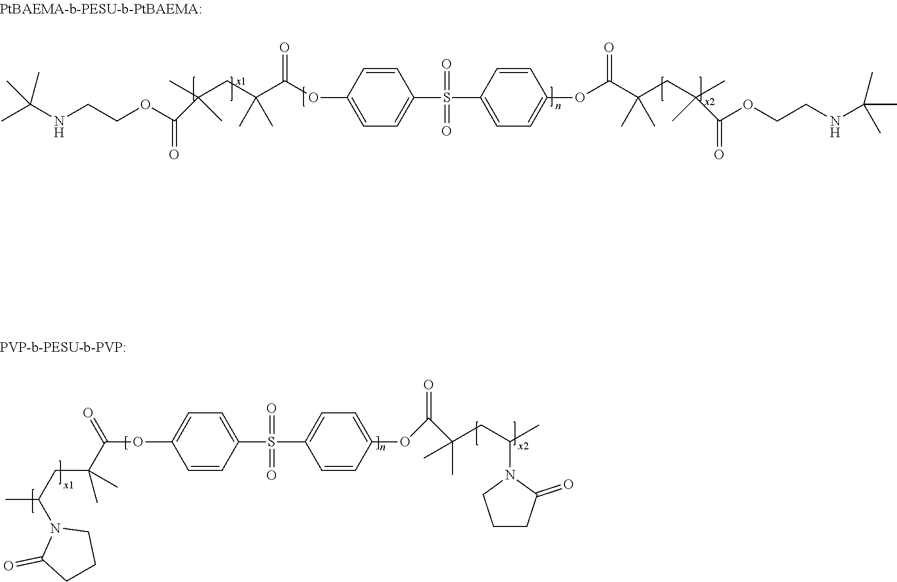

or combinations thereof,
wherein x¹, x², n and m in the above formulae are defined as above in anyone of the preferred embodiments.

In a particular preferred embodiment, the functional polymer P2 is an amphiphilic polyethersulfone block copolymer P2.1 selected from a PPEGMA-b-PESU-b-PPEGMA or combinations thereof.

According to another embodiment, the functional polymer P2 is an amphiphilic polyethersulfone block copolymer P2.1 having a Mw in the range of 10.000 to 100.000, like 15.000 to 80.000, in particular 20.000 to 60.000 g/mol, as determined by Gel Permeation Chromatography (GPC) with N-dimethylacetamide (DMAc) solution.

According to another embodiment, the functional polymer P2 is an amphiphilic polyethersulfone block copolymer P2.1 having a polydispersity index in the range of 1.5 to 5, or 2 to 3, as determined by Gel Permeation Chromatography (GPC) with N-dimethylacetamide (DMAc) solution.

The amphiphilic polyethersulfone block copolymer P2.1 may be prepared by any known method, specifically by polymerization reactions of appropriate monomers and/or macromonomers. In particular, radical polymerization reactions are preferred. From the viewpoint of reaction control, an atom transfer radical polymerization (ATRP) is preferred. Specific embodiments concerning the preparation of the amphiphilic polyethersulfone block copolymer P2.1 are disclosed in WO 2015/075178 A1. In particular, reference is made to page 13, line 12 to page 14, line 12 of this document.

### Specific Embodiments for Polymeric Material P2.2

According to an embodiment of the present invention, the functional layer F of the hollow fibre membrane M comprises an amphiphilic polymer material P2.2, which is a partially sulfonated poly(arylene ether sulfone) copolymer comprising at least one unit (C) and at least one block unit (D) as defined above.

In one embodiment, the amphiphilic polymer P2 preferably essentially consists of the amphiphilic partially sulfonated poly(arylene ether sulfone) block copolymer P2.2. This means that the amphiphilic polystyrene block copolymer P2.2 constitutes ≥97% by weight, preferably ≥98% by weight, in particular ≥99% by weight of the material of the amphiphilic polymer P2.

In an preferred embodiment, about 0.5 to 5 or 1 to 3.5 mol-% of the monomeric constituents or repeating units, i.e. units (C) and (D), of said partially sulfonated poly(arylene ether sulfone) block copolymer P2.2 carry at least one sulfo group.

The partially sulfonated poly(arylene ether sulfone) block copolymer poly(arylene ether sulfone) block copolymer P2.2 is obtainable by polymerizing appropriate non-sulfonated monomers and at least one sulfonated monomer as described in WO 2013/156598 A1. In particular, reference is made to page 5, line 30 to page 7, line 16 of this document.

In one embodiment, the partially sulfonated poly(arylene ether sulfone) copolymer poly(arylene ether sulfone) copolymer P2.2 comprises a non-sulfonated repeating unit of formula (1):

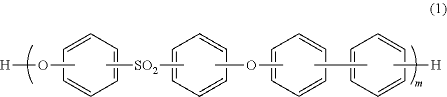

and a sulfonated repeating unit of formula (2):

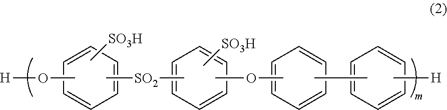

wherein n and m are defined as above.

In another embodiment, the partially sulfonated poly(arylene ether sulfone) copolymer P2.2 comprises a non-sulfonated repeating unit of formula (1a):

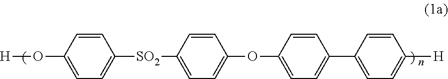

and a sulfonated repeating unit of formula (2a):

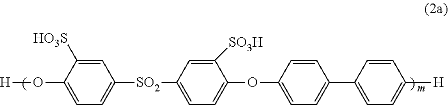

wherein n and m are defined as above.

In one embodiment, the partially sulfonated repeating unit (2a) is contained in a molar ratio of 0.1 to 20, 0.2 to 10, in particular 0.5 to 5 or 1 to 3.5 mol-% based on the total mole number of repeating units (1) and (2), or (1a) and (2a), respectively.

In a further preferred embodiment, the functional polymer P2 is an amphiphilic partially sulfonated poly(arylene ether sulfone) copolymer P2.2 essentially consisting of the repeating unit (2a).

According to another embodiment, the functional polymer P2 is an amphiphilic partially sulfonated poly(arylene ether sulfone) block copolymer P2.2 having a Mw in the range of 25,000 to 150,000, in particular 50,000 to 100,000 g/mol, as determined by Gel Permeation Chromatography (GPC) with N-dimethylacetamide (DMAc) solution. If the Mw is above 150,000 g/mol then the solution viscosity of the polymer it too high. If the Mw is below 25,000 g/mol, then the obtained membranes show limited mechanical strength.

According to another embodiment, the functional polymer P2 is an amphiphilic partially sulfonated poly(arylene ether sulfone) copolymer P2.2 having a polydispersity index in the range of 1.5 to 5, or 2 to 3, as determined by Gel Permeation Chromatography (GPC) with N-dimethylacetamide (DMAc) solution.

According to one embodiment, the amphiphilic partially sulfonated poly(arylene ether sulfone) copolymer P2.2 comprising at least one block unit (C) and at least one block unit (D) has the structure D-C, D-C-D or -(-D-C-D-C-)-.

According to a preferred embodiment, the structure of the amphiphilic partially sulfonated poly(arylene ether sulfone) copolymer P2.2 is -(-D-C-D-C-)-.

According to another embodiment, the functional polymer P2 is an amphiphilic partially sulfonated poly(arylene ether sulfone) copolymer P2.2 comprising at least one unit (C) in an amount in the range of 1 to 70 wt.-% and in particular 10 to 60 wt.-% per total weight of the dried copolymer P2.2.

Examples of the partially sulfonated poly(arylene ether sulfone) copolymer P2.2 may include but are not limited to:

sPPSU:

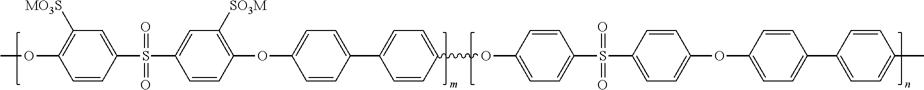

wherein m and n can be an integer from 0 to 1 and M represents H, Na or K.

The preparation of polymer P2.2 is generally performed by applying standard methods of polymer technology as described in WO 2013/156598 A1, page 10, line 23 to page 12, line 21.

### Specific Embodiments for Polymeric Material P2.3

According to an embodiment of the present invention, the functional layer F of the hollow fibre membrane M comprises a polymeric material P2.3, which is an amphiphilic polystyrene block copolymer comprising at least one block unit (E) and at least one block unit (F) as defined above.

In one embodiment, the amphiphilic polymer P2 preferably essentially consists of the amphiphilic polystyrene block copolymer P2.3. This means that the amphiphilic polystyrene block copolymer P2.3 constitutes ≥97% by weight, preferably ≥98% by weight, in particular ≥99% by weight of the material of the amphiphilic polymer P2.

In one embodiment, R¹, R² independently are preferably hydrogen or alkyl, like C₁-C₄-alkyl (e.g. methyl). In particular, R¹, R² independently are hydrogen or methyl.

R³ is preferably hydrogen, an optionally substituted alkyl having 1 to 6 carbon atoms (e.g. Methyl, Ethyl, or Propyl) or an aryl, optionally substituted with 1 or 2 sulfonic acid group.

R⁴ is preferably hydrogen or a sulfonic acid group.

R⁵ is preferably —CO(O-alkylene)ₘ—OR⁷, —CO(O-alkylene)ₘ—SO₃⁻M⁺, —CO(O-alkylene)ₘ—NHR⁸, —CO(O-alkylene)ₘ—N⁺R⁸R⁹R¹¹ W⁻, or —CO(O-alkylene)ₘ—NR⁸R⁹R¹⁰. Alkylene is in particular C₂-C₄ alkylene. In particular, R¹ is —CO(O—(CH₂)₂)ₘ—OR⁷, —COO—(CH₂)₃—SO₃⁻M⁺, —COO—(CH₂)₂—N⁺R⁸R⁹R¹¹W⁻, or —COO—(CH₂)₂—NR⁸R⁹R¹⁰.

R⁶ is hydrogen, or an optionally substituted alkyl having 1 to 6 carbon atoms.

R⁷ is preferably hydrogen or alkoxy-alkyl (e.g. 2-methoxy-ethyl); in particular, R⁷ is hydrogen or 2-methoxy-ethyl.

Preferably, R⁸ and R⁹ independently are hydrogen or alkyl, like C₁-C₄-alkyl (e.g. Me, tBu). In particular, R⁸ and R⁹ independently are hydrogen, methyl, or tert-butyl.

R¹⁰ is preferably C₂-C₄ alkylene-SO₃H (e.g. —(CH₂)₃SO₃H); in particular, R¹⁰ is —(CH₂)₃SO₃H.

R¹¹ is preferably hydrogen.

M is preferably an alkaline metal (e.g. K).

W is preferably halogen, like Cl or F.

In a further, particular preferred embodiment, the amphiphilic polystyrene block copolymer P2.3 comprises at least one block unit (E) and at least one block unit (F) as defined above, wherein:

R¹, R² independently are hydrogen or methyl, preferably hydrogen;

R³ is hydrogen or methyl, preferably hydrogen;

R⁴ is hydrogen;

R⁵ is —CO(O—(CH₂)₂)ₘ—OR⁷, —CO(O—(CH₂)₃)ₘ—SO₃⁻M⁺, —CO(O—(CH₂)₂)ₘ—N⁺R⁸R⁹R¹¹ W⁻, or —CO(O—(CH₂)₂)ₘ—NR⁸R⁹R¹⁰, in particular —CO(O—(CH₂)₂)ₘ—OR⁷;

R⁶ is hydrogen, a methyl group or an ethyl group, in particular a methyl group;

R⁷ is 2-methoxy-ethyl;

R⁸ and R⁹ independently are hydrogen, or methyl;

R¹⁰ is —(CH₂)₃SO₃H;

R¹¹ is hydrogen;

M is K;

W is Cl;

n, o independently are integer in a range from 40 to 50; and

m is an integer in a range from 5 to 10, preferably 7 to 10.

According to one embodiment, the amphiphilic polystyrene block copolymer P2.3 comprises at least one hydrophobic block unit (E) and at least one hydrophilic block unit (F) and has the structure F-E, F-E-F or -(-F-E-F-E)-.

According to a preferred embodiment, the structure of the amphiphilic polystyrene block copolymer P2.3 is -(-F-E-F-E)-.

According to another embodiment, the functional polymer P2 is an amphiphilic polystyrene block copolymer P2.3 comprising at least one unit (E) in an amount in the range of 1 to 60 wt.-% and in particular 10 to 50 wt.-% per total weight of the dried block copolymer P2.3.

An example of an amphiphilic polystyrene block copolymer P2.3 may include but is not limited to PS-b-PEGMA:

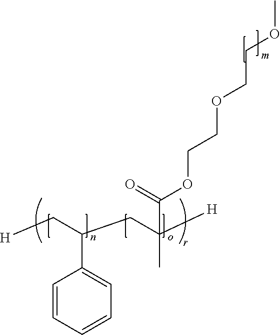

wherein n, o and m are defined as above and r is an integer in the range from 1 to 20.

According to another embodiment, the functional polymer P2 is an amphiphilic polystyrene block copolymer P2.3 having a Mw in the range of 80,000 to 600,000, in particular 170,000 to 320,000 g/mol, as determined by Gel Permeation Chromatography (GPC) with N-dimethylacetamide (DMAc) solution.

According to another embodiment, the functional polymer P2 is an amphiphilic polystyrene block copolymer P2.3 having a polydispersity index in the range of 1 to 2.5, preferably 1 to 2, in particular 1.1 to 1.6, as determined by Gel Permeation Chromatography (GPC) with N-dimethylacetamide (DMAc) solution.

The block copolymers can be synthesized by methods known in the art. For example, the copolymers can be synthesized using anionic polymerization, atom transfer radical polymerization (ATRP), or other suitable polymerization techniques. In particular, from the viewpoint of a low polydispersity index, anionic polymerization techniques are preferred. The polystyrene block copolymers P2.3 can be also be obtained commercially.

### Specific Embodiments for Polymeric Material P2.4

According to an embodiment of the present invention, the amphiphilic polymer P2 of the hollow fibre membrane M comprises an amphiphilic polystyrene block copolymer P2.4 comprising at least one block unit (G) and at least one block unit (H) as defined above.

Preferably, the amphiphilic polymer P2 essentially consists of the amphiphilic polystyrene block copolymer P2.4. This means that the amphiphilic polystyrene block copolymer P2.4 constitutes ≥97% by weight, preferably ≥98% by weight, in particular ≥99% by weight of the material of the amphiphilic polymer P2.

In the above block units (G) and (H), R¹, R² independently are preferably hydrogen or alkyl, like C₁-C₄-alkyl (e.g. methyl). In particular, R¹, R² independently are hydrogen or methyl.

R³ is hydrogen, an alkyl, like C₁-C₄-alkyl (e.g. methyl) or an aryl, like phenyl.

R⁴ is preferably hydrogen or a sulfonic acid group, in particular hydrogen.

n, m independently are integer in a range from 20 to 80, preferably 30 to 70 or 40 to 50.

In a particular preferred embodiment E² represents a carbon atom and either E¹ or E³ represents a nitrogen atom, while the other represents a carbon atom.

In one embodiment, the polymer P2.4 comprises in addition to the hydrophilic block unit (H) more than one different hydrophobic block units (G), e.g. one hydrophobic block unit (G) and one hydrophobic block unit (G′), wherein (G′) is represented by the following formula:

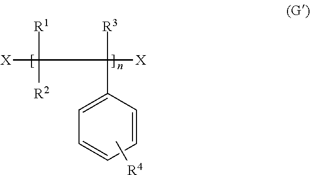

wherein R¹, R², R³, R⁴, X and n are defined as above, and (G) and (G′) are different from each other.

The block units (G) and (G′) may be comprised in the amphiphilic polystyrene block copolymer in form of a block of a random, statistic or alternating copolymer of the block unit (G) and the block unit (G′) or in form of blocks comprising either the block unit (G) or the block unit (G′).

According to one embodiment, the amphiphilic polystyrene block copolymer P2.4 comprises at least one hydrophobic block unit (G) and at least one hydrophilic block unit (H) and has the structure H-G, H-G-H, -(-H-G-H-G-)-, -(-H-G′-G-H-G′-G-)- or -(-H-G′-H-G-)-.

According to a preferred embodiment, the structure of the amphiphilic polystyrene block copolymer P2.4 is -(-H-G′-G-H-G′-G-)-.

According to another embodiment, the functional polymer P2 is an amphiphilic polystyrene block copolymer P2.4 comprising at least one unit (G) or (G′) in an amount in the range of 1 to 70 wt.-% and in particular 10 to 60 wt.-% per total weight of the dried block copolymer P2.4.

Examples of the amphiphilic polystyrene block copolymer P2.4 may include but are not limited to

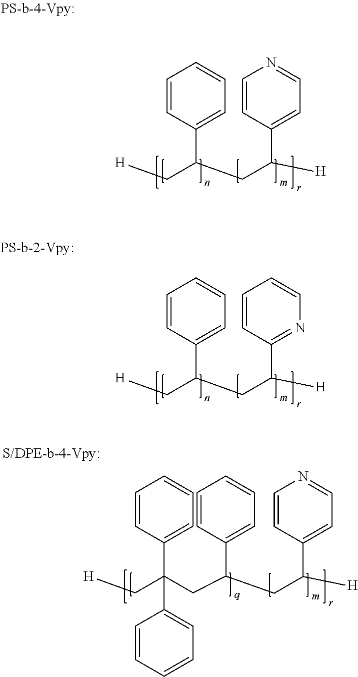

wherein n and m are defined as above, r is at each occurrence an integer in the range from 1 to 20 and q is n/2. The maximum ratio of S/DPE is 1:1 mol/mol.

According to another embodiment, the functional polymer P2 is an amphiphilic polystyrene block copolymer P2.4 having a Mw in the range of 80,000 to 600,000, in particular 170,000 to 320,000 g/mol, as determined by Gel Permeation Chromatography (GPC) with N-dimethylacetamide (DMAc) solution.

According to another embodiment, the functional polymer P2 is an amphiphilic polystyrene block copolymer P2.4 having a polydispersity index in the range of 1 to 2.5, preferably 1 to 2, in particular 1.1 to 1.6, as determined by Gel Permeation Chromatography (GPC) with N-dimethylacetamide (DMAc) solution.

The block copolymers can be synthesized by methods known in the art. For example, the copolymers can be synthesized using anionic polymerization, or other suitable polymerization techniques.

### Specific Embodiments for Polymeric Material P2.5

According to a further embodiment of the present invention, the amphiphilic polymer P2 comprises an amphiphilic poly(arylene ether sulfone) block copolymer P2.5 comprising at least one block unit (I) and at least one block unit (J) as defined above.

In one embodiment, the amphiphilic polymer P2 essentially consists of the amphiphilic poly(arylene ether sulfone) block copolymer P2.5. This means that the amphiphilic poly(arylene ether sulfone) block copolymer P2.5 constitutes ≥97% by weight, preferably ≥98% by weight, in particular ≥99% by weight of the material of the amphiphilic polymer P2.

In the above defined block units (I) and (J), R¹, R² independently are linear, branched or cyclic alkyls having 1 to 18 carbon atoms, a further block unit (I) or a block unit (J). In a preferred embodiment, R¹, R² are independently linear alkyls having 1 to 12 carbon atoms, like ethyl, propyl, butyl, pentyl, hexyl, heptyl, octyl, nonyl, decyl, undecyl or dodecyl-moieties, a further block unit (I) or a block unit (J).

R⁵, R⁶ independently are hydrogen, halogen, or a sulfonic acid group, preferably a hydrogen or a sulfonic acid group, in particular a sulfonic acid group.

n is an integer in a range from 1 to 10, preferably from 2 to 7, like 4, 5 or 6.

m is an integer in a range from 20 to 80, preferably 30 to 70 or 40 to 50.

According to another embodiment, the functional polymer P2 is an amphiphilic poly(arylene ether sulfone) block copolymer P2.5 having a Mw in the range of 50,000 to 150,000, in particular 70,000 to 100,000 g/mol, as determined by Gel Permeation Chromatography (GPC) with N-dimethylacetamide (DMAc) solution.

According to another embodiment, the functional polymer P2 is an amphiphilic poly(arylene ether sulfone) block copolymer P2.5 having a polydispersity index in the range of 1.5 to 5, or 2 to 3, as determined by Gel Permeation Chromatography (GPC) with N-dimethylacetamide (DMAc) solution.

According to one particularly preferred embodiment, the amphiphilic poly(arylene ether sulfone) block copolymer P2.5 comprising at least one block unit (I) and at least one block unit (J) has a structure, wherein the block units (I) form a poly(siloxane) network of cross-linked block units (I). In one embodiment, the cross-linked poly(siloxane) network constitute a polymeric core. Polymeric chains formed from block units (J) (i.e. homopolymer chains) or block units (J) and block units (I) (i.e. copolymer chains) are grafted to the surface of the cross-linked poly(siloxane) core.

According to another embodiment, the functional polymer P2 is an amphiphilic poly(arylene ether sulfone) block copolymer P2.5 comprising at least one unit (I) in an amount in the range of 1 to 50% and in particular 2 to 20 wt. % per total weight of the dried block copolymer P2.5.

Examples of the amphiphilic poly(arylene ether sulfone) block copolymer P2.5 may include but is not limited to

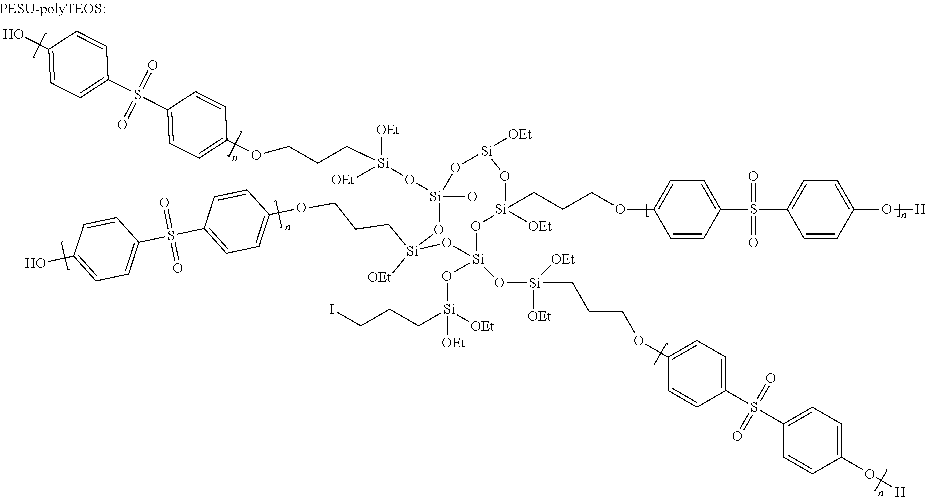

wherein n is an integer in a range from 5 to 80.

The amphiphilic poly(arylene ether sulfone) block copolymer P2.5 may be prepared by every known method. For example, a mixture of a tetraalkoxysilane, e.g. tetraethoxysilane (TEOS), and a haloalkyl(trialkoxy)silane, e.g. 3-iodo-n-propyl-trimethoxysilane, is reacted at elevated temperature under basic conditions (e.g. 135° C. in the presence of acetic anhydride) to result in a poly(siloxane) core, which is substituted with halogenated alkyl groups. Poly(arylene ether sulfone) chains may be attached to the halogenated alkyl groups by reacting both compounds at elevated temperatures under basic conditions (e.g. in dimethylformamide (DMF) at 60° C. in the presence of NaH).

### Specific Embodiments of the Hollow Fibre Membrane M

According to the present invention multilayer single-bore hollow fibre membranes M or multilayer multi-bore hollow fibre membranes M for ultrafiltration applications are provided, comprising at least one substrate S comprising a bulk material P1 and at least one functional layer F disposed on at least the inner surface of the hollow fibre membrane M substrate, wherein the functional layer F comprises at least one functionalized material P2.

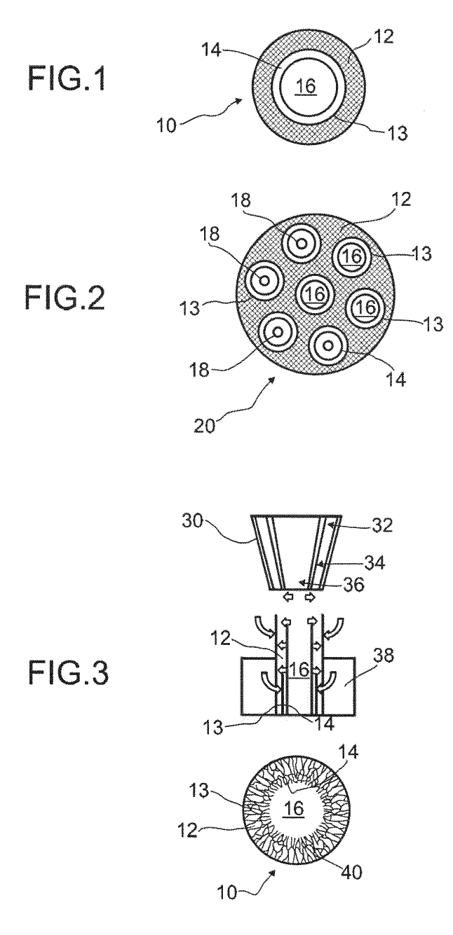

FIG. 1 shows a multilayer single-bore hollow fibre membrane 10 (M).

The multilayer single-bore hollow fibre membrane 10 (M) according to FIG. 1 includes a substrate 12 (S) of annular shape having a surface 13. Here, the surface 13 is directed towards the center of the annular shape of the substrate 12 (S) and therefore is an inner surface 13. Onto said surface 13 a material of a functional layer 14 (F) is applied. The functional layer 14 (F) surrounds a bore 16 for a liquid to be treated or filtered.

The single-bore hollow fibre membrane 10 (M) given here contains exactly two layers, namely the substrate 12 (S) and the functional layer 14 (F). But, another functional layer 14 (F) could be applied to an outer surface of the substrate 12 (S). Furthermore, one or more functional layers 14 could be applied to a functional layer 14 (F) that is applied directly to the surface 13 of the substrate 12 (S). Hence, the single-bore hollow fibre membrane 10 (M) could contain for example three, four or more layers.

The substrate 12 (S) is substantially made of a polymer P1 such as polyethersulfone (PESU) material providing a mechanical support and being the bulk material. The material of the functional layer 14 (F) adopts an anti-fouling function and/or an isoporous function. According to the present invention, the material of the functional layer 14 (F) is concentrated in a relatively thin layer thickness, so that high efficiency on the one hand and on the other hand lower material costs can be achieved. The material to be chosen to apply a functionality according to the properties of the functional layer F gives a high flexibility to tailor the material of the functional layer 14 (F) according to the applications envisaged, for instance ultrafiltration applications. Since the material having the functional properties, i.e. functional layer 14 (F), can be chosen independently from the material for the substrate 12 (S), no change of the bulk material property, i.e. no change of the material P1 for the substrate 12 (S), is necessary.

According to FIG. 2, a multilayer multi-bore hollow fibre membrane 20 (M) is shown.

According to FIG. 2, the multilayer multi-bore hollow fibre membrane 20 (M) comprises the substrate 12 (S), i.e. a first polymer P1, with a circular cross-section having several, presently seven, holes (bores) arranged therein. Preferably, the multilayer multi-bore hollow fibre membrane 20 (M) comprises the substrate 12 (S) with a circular cross-section having from 2 to 15, in particular 3 to 8, holes (bores) arranged therein. The surface 13 of the substrate 12 (S) is the amount of area at the sides of said holes (bores) directed towards the centers of said holes (bores) and therefor is an inner surface 13. The multilayer multi-bore hollow fibre membrane 20 (M) also comprises the material forming the functional layer 14 (F) on the respective surface 13 of the material of the substrate 12 (S). The functional layer 14 (F) surrounds several bores 16 for the liquid to be treated or filtered.

The multi-bore hollow fibre membrane 20 (M) given here contains exactly two layers, namely the substrate 12 (S) and the functional layer 14 (F). But, another functional layer 14 (F) could be applied to an outer surface of the substrate 12 (S). Furthermore, one or more functional layers 14 could be applied to a functional layer 14 (F) that is applied directly to the surface 13 of the substrate 12 (S). Hence, the multi-bore hollow fibre membrane 10 (M) could contain for example three, four or more layers.

Reference numeral 18 depicts the flow direction of said liquid to be treated; a liquid to be treated may be either sea water or waste water, to give examples.

While the material for substrate 12 (S) is considered to be the bulk material, it usually is a first polymer which offers mechanical support such as for example polyethersulfone (PESU) material.

The material forming the functional layer 14 (F), a second polymer may implement an anti-fouling function or an isoporous function or both of them.

In one embodiment of the present invention the polymeric bulk material P1 essentially consists of polyethersulfone (PESU) and the amphiphilic polymer P2 essentially consists of an amphiphilic polyethersulfone block copolymer P2.1 represented by the following formula (PPEG-MA-b-PESU-b-PPEGMA):

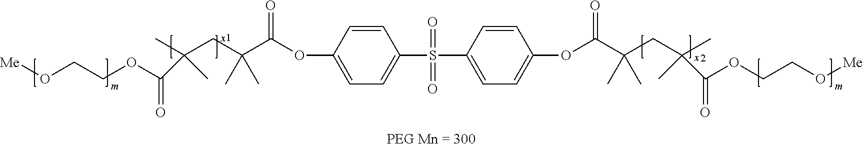

wherein m and n are defined as above.

In another embodiment of the present invention the polymeric bulk material P1 essentially consists of polyethersulfone (PESU) and the amphiphilic polymer P2 essentially consists of an amphiphilic partially sulfonated poly(arylene ether sulfone) copolymer P2.2 represented by the following formula (sPPSU):

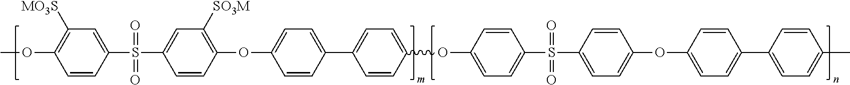

wherein m is 0.975 and n is 0.025 and M represents H, Na or K.

In a still further embodiment of the present invention the substrate polymer P1 essentially consists of polyethersulfone (PESU) and the amphiphilic polymer P2 essentially consists of an amphiphilic polystyrene block-copolymer P2.3 represented by the following formula (PS-b-PEGMA):

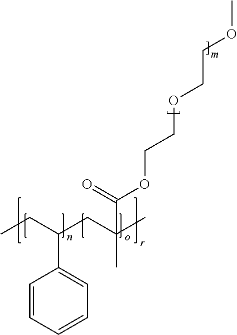

wherein n, o and m are defined as above and r is an integer in the range from 1 to 20.

In a still further embodiment of the present invention the substrate polymer P1 essentially consists of polyethersulfone (PESU) and the amphiphilic polymer P2 essentially consists of a PESU-PEO multiblock copolymers according to the following formula (PESU-PEO):

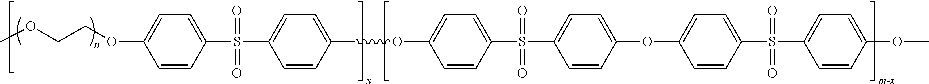

wherein m is 1, x is 0.03 and n is 45.

In a still further embodiment of the present invention the substrate polymer P1 essentially consists of polyethersulfone (PESU) and the amphiphilic polymer P2 essentially consists of a PSU-PEO-Polysiloxane multiblock copolymers according to the following formula (PSU-Si):

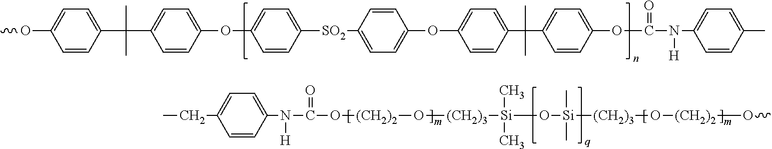

wherein n is from >0 to 100, m is from 0 to 50 and q is from 0 to 50. Preferably, n is from ≥2 to 80, m is from 0 to 45 and q is from 0 to 45.

In a still further embodiment of the present invention the substrate polymer P1 essentially consists of polyethersulfone (PESU) and the amphiphilic polymer P2 essentially consists of an amphiphilic polystyrene block-copolymer P2.4 represented by the following formula (S/DPE-b-4-Vpy):

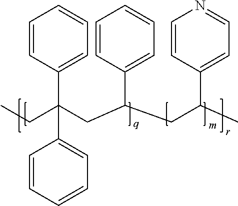

wherein r is an integer in the range from 1 to 20, q is n/2, and n and m are defined as above. The maximum ratio of S/DPE is 1:1 mol/mol

In a still further embodiment of the present invention the substrate polymer P1 essentially consists of polyethersulfone (PESU) and the amphiphilic polymer P2 essentially consists of an amphiphilic poly(arylene ether sulfone) block copolymer P2.5 represented by the following formula (PES-polyTEOS):

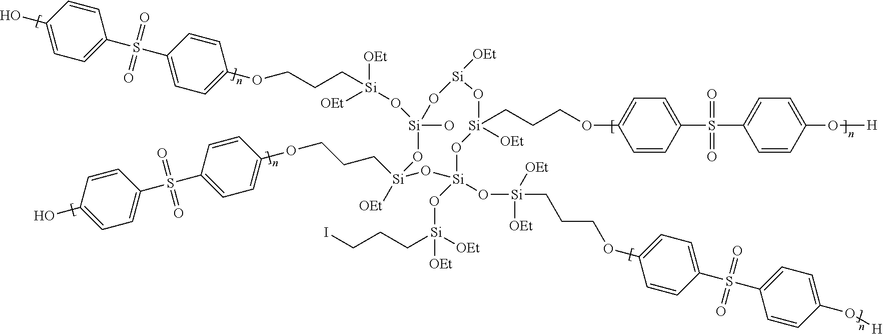

wherein n is an integer in a range from 20 to 80.

According to FIG. 3, a multilayer single-bore hollow fibre membrane 10 (M) as shown in FIG. 1 is fabricated in a spinneret 30 which is shown here schematically only. According to the schematic view in FIG. 3, said spinneret 30 includes a flow 32 of a first polymer, a flow 34 of a second polymer and a flow 36 of a bore fluid. Said first polymer, said second polymer and said bore fluid are fed to the spinneret 30 substantially simultaneously. At the lower hand of the outlet side of the spinneret 30, a tube-shaped string of a multilayer single-bore hollow fibre membrane 10 (M) is formed. Said tube-shaped string is fed to a precipitation bath 38. In the area of the precipitation bath 38, it can be derived from FIG. 3 that said material of the functional layer 14 (F) has a relatively thin thickness as compared to the thickness of the material of the substrate 12 (S). A bore 16 within the hollow multilayer single-bore hollow fibre membrane 10 (M) is maintained by said bore fluid 36, which is fed to the center portion of the spinneret 30 according to the schematically given view in FIG. 3.

FIG. 3 still further shows a top view of a multilayer single-bore hollow fibre membrane 10 (M). It can be derived from FIG. 3 that the relatively thin material of the functional layer 14 (F) is arranged on the surface 13 of the tube-like shaped material for forming the substrate 12 (S), i.e. the first polymer. The bore 16 allows a flow of liquid to be treated by means of the multilayer single-bore hollow fibre membrane 10 (M) according to the present invention.

The flow 32 of a first polymer and the flow 34 of a second polymer are realized by solutions of the polymers, i.e. the bulk polymer P1, the amphiphilic polymer P2, and/or optionally additives such as pore forming agents, in appropriate solvents or solvent mixtures. Suitable solvents or solvent mixtures for preparing said polymeric solutions contain at least one solvent selected from N-methylpyrrolidone (NMP), N-dimethylacetamide (DMAc), dimethylsulfoxide (DMSO), dimethylformamide (DMF), triethylphosphate, tetrahydrofuran (THF), 1,4-dioxane, methyl ethyl ketone (MEK), acetonitrile, dichloromethane (DCM), water or a combination thereof.

The polymer solution of the at least one bulk polymer P1 and/or the at least one amphiphilic polymer P2 preferably comprises 60 to 90 wt.-%, in particular 70 to 80 wt.-% of solvent with respect to the weight of the entire polymer solution. In a preferred embodiment, the polymer solution comprises 70 to 80 wt.-% of NMP.

Preferably, the polymer solution comprises the at least one bulk polymer P1 and/or the at least one amphiphilic polymer P2 in an amount of 1 to 40 wt.-%, more preferably 5 to 30 wt.-%, and in particular 10 to 25 wt.-%, based on the weight of the entire polymer solution.

The polymer solution may further comprise glycerin as an additive to improve the membrane formation. Glycerin may be present in the polymer solution in an amount of up to 15 wt.-%, e.g. in an amount of 1 to 10 wt.-% of the entire polymer solution.

Besides the bulk polymer P1 and/or the amphiphilic polymer P2 the polymer solutions may further comprise pore forming agents such as polyethylene glycol (PEG) and polyvinylpyrrolidone (PVP). The pore forming agents may be present in the polymer solution in an amount of up to 15 wt.-%, e.g. in an amount of 1 to 10 wt.-% of the entire polymer solution.

The bore fluid comprises water as a main component. The water content amounts to at least 70 wt.-% of the bore fluid. In one embodiment, the bore fluid consists of water. In a further embodiment, the bore fluid is a mixture of water and the above mentioned solvent of the polymer solutions and comprises 80 to 95 wt.-% of water. For example, the bore fluid is a mixture of NMP and water in a ratio of 10 wt-% to 90 wt.-%.

The precipitation bath 38 comprises water as a main component. The water content is at least 90 wt.-% of the precipitation bath 38. Additionally, precipitation additives may be added, e.g. salts such as NaCl. The precipitation bath advantageously has a temperature of about 40 to 70° C., in particular 40 to 50° C.

Following the precipitation of the inventive multilayer single-bore hollow fibre membranes or multilayer multi-bore hollow fibre membranes, the membranes may be washed to remove impurities such as additives and or solvent residues. Preferably, water is used as solvent for the washing process. The pore forming agents may be removed from the membrane by etching methods. These are principally known in the art. For example, etching may be effected by an aqueous solution of an hypochlorite. For example, the solution comprises sodium hypochlorite in an amount of 500 to 10,000 ppm and has a temperature of 40 to 70° C. The solution is reacted with the membrane for example for 1 to 10 hours.

The present invention further relates to an ultrafiltration membrane comprising at least one hollow fibre membrane as described above.

According to another embodiment, the present invention is directed to an ultrafiltration method making use of said hollow fibre membranes. In particular, said ultrafiltration method is applied for hemodialysis, protein separation/fractionation, virus removal, recovery of vaccines and antibiotics from fermentation broths, wastewater treatment, milk/dairy product concentration, concentration of fruit juice, etc. In particular, the treatment of waste water is a preferred application of the hollow fibre membranes according to the invention.

According to one embodiment, the amphiphilic block copolymer (P2) according to the invention is used as antifouling agent and/or pore size control agent in hollow fibre membranes.

According to another embodiment, the present invention is directed to a filtration module making use of said hollow fibre membranes. In a preferred embodiment, the filtration module comprises multiple hollow fibre membranes, e.g. 10 to 20,000, in particular 1000 to 10,000 hollow fibre membranes.

### EXAMPLES

### General Procedure

Polyethersulfone (Ultrason E3010), polyvinylpyrrolidone (PVP) K90 and the respective amphiphilic polymer P2 were dried under vacuum at 100° C. prior to use. Dope formulations for the inner layer and outer layer were prepared as listed in the following examples. The polymer solutions were loaded into the pumps and left to degas overnight. Dual-layer hollow fiber membranes were fabricated according to the parameters listed in the examples below. The fabricated membranes were left in water overnight to ensure complete removal of the solvent. Subsequently, the membranes were etched in 2000 ppm sodium hypochlorite solution at 60° C. for 2 hours and followed by washing in distilled water for 3 times. A bundle of membranes were freeze-dried for further characterization while another bundle was soaked in a 50/50 wt.-% glycerol/water mixture for 2 days and left to air dry thereafter. 5 air dried hollow fiber membranes were assembled in each lab-scale module for testing of water permeability and molecular weight cut-off (MWCO). Water permeability tests were carried out on an in-house ultrafiltration setup using distilled water at a transmembrane pressure of 0.4 bar and flowrate of 0.4 L/min. MWCO tests were carried out by circulating a 1000 ppm PEG/PEO solution at 0.15 bar at 0.4 L/min for 15 minutes before collection of the permeates for analysis with a gel permeation chromatograph (GPC).

Fouling tests using flower soil were carried out to determine the anti-fouling property of the membranes. The flower soil stock solution was diluted 2000 times and prepared at pH 8.0. Fouling cycles of 30 minute intervals at 0.6 bar, 0.4 L/min were repeated three times, with 1 hour of washing with distilled water in between. The ability to recover its initial water permeability after 3 cycles of fouling was used to determine the anti-fouling ability of the membrane. The flower soil solution was made up of ˜65% humics with the rest comprising building blocks, bio-polymers, low molecular weight organic acids and neutrals.

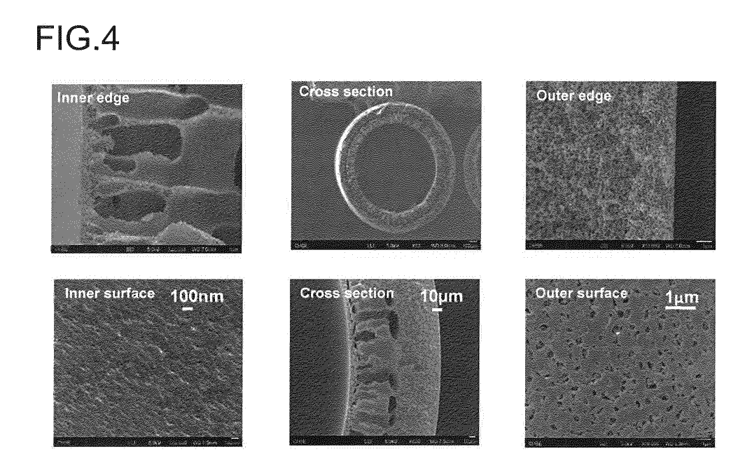

Field emission scanning electron microscopy (FESEM) was employed to prepare images of the obtained hollow fibre membranes. In particular, the inner edge, the outer edge, the inner surface, the outer surface and the cross section were examined. The images are shown in FIGS. 4 to 10.

Dried membranes fractured in liquid nitrogen and sputtered with platinum by a JEOL JFC-1100E Ion Sputtering device were loaded into the FESEM (JEOL JSM-6700) for morphology observation.

### Example 1

PESU-PEO multiblock copolymers according to the following formula (E1) were applied as amphiphilic polymer P2:

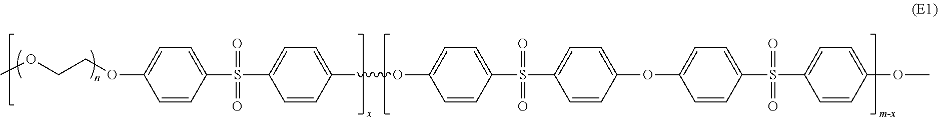

wherein m is 1, x is 0.03 and n is 45.

The compositions of the dual-layer ultra filtration hollow fiber (DL-UF-HF) membranes comprising the PESU-PEO multiblock copolymer are given in Table 1. Test results obtained with these membranes are given in Table 2. FESEM images are shown in FIG. 4.

TABLE 1
Dope formulations and spinning parameters for dual layer hollow fiber
membranes with PESU-PEO-multiblockcopolymers in the inner layer

| | DL-UF-HF- | DL-UF-HF- | DL-UF-HF- |
|---|---|---|---|
| Name | PESU-PEO-1A | PESU-PEO-1B | PESU-PEO-1C |
| Inner Dope | PESU E3010/PESU-PEO/ | | |
| composition (wt %) | Glycerin/NMP = 3/13/4/80 | | |
| Outer Dope | PESU E3010/PVP K90/ | | |
| composition (wt %) | Glycerin/NMP = 13/6/8/73 | | |
| Inner Dope | 0.5 | 0.5 | 0.5 |
| flow rate (ml/min) | | | |
| Outer Dope | 2 | 2 | 1.6 |
| flow rate (ml/min) | | | |
| Bore composition | water | water | water |
| (wt %) | | | |
| Bore flow | 2.5 | 2.5 | 2.5 |
| rate (ml/min) | | | |
| Air gap (cm) | 20 | 10 | 10 |
| Take up speed (cm/s) | 6 | 5 | 5 |

| | |
|---|---|
| External coagulant | Tap water (50 ± 2° C.) |
| (wt %) | |

TABLE 2
Water permeability and MWCO results
for dual layer hollow fiber membranes
with PESU-PEO-multiblockcopolymers
in the inner layer

| | Water | |
|---|---|---|
| | permeability | MWCO |
| Membrane ID | (LMH/bar) | (kDa) |
| DL-UF-HF-PEO-1A | 1021 ± 77 | 22 ± 2 |
| DL-UF-HF-PEO-1B | 1405 ± 113 | 30 ± 0.4 |
| DL-UF-HF-PEO-1C | 1785 ± 54 | 31 ± 2 |

The DL-UF-HF-PEO-1A membranes have a 54.0±4.8% recovery in its initial water permeability after fouling tests.

### Example 2

PESU-b-PEGMA multiblock copolymers according to the following formula (E2) were applied as amphiphilic polymer P2:

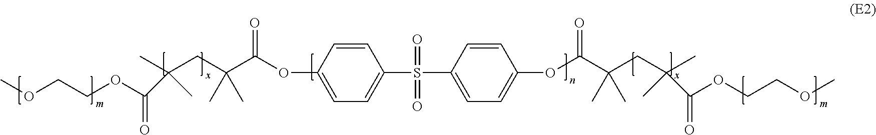

wherein m is 1 n is 2 and x is 3.35.

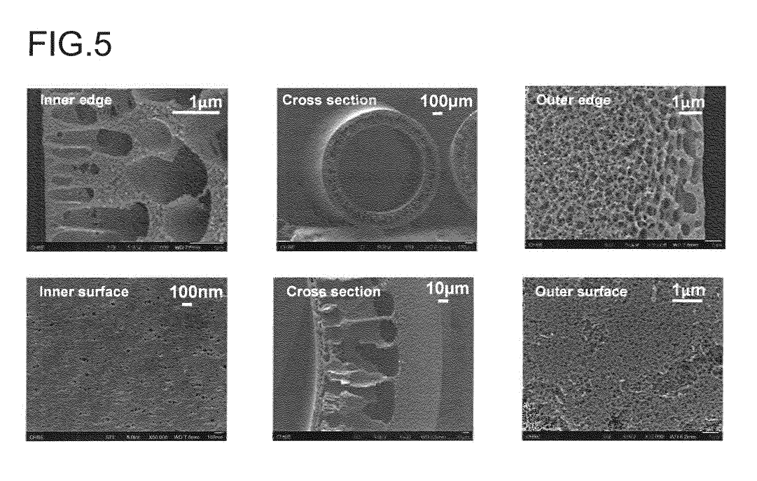

The compositions of the dual-layer ultra filtration hollow fiber (DL-UF-HF) membranes comprising the PESU-b-PEGMA multiblock copolymer are given in Table 3. Test results obtained with these membranes are given in Table 4. FESEM images are shown in FIG. 5.

TABLE 3
Dope formulations and spinning parameters for dual layer hollow
fiber membranes with PESU-b-PEGMA in the inner layer

| | DL-UF-HF- | DL-UF-HF- | DL-UF-HF- | DL-UF-HF- |
|---|---|---|---|---|
| Name | MM1-2A | MM1-2B | MM1-2C | MM1-2D |
| Inner Dope | PESU E3010/MM1/Glycerin/NMP = 11/5/4/80 | | | |
| composition (wt %) | | | | |
| Outer Dope | PESU E3010/PVP K90/Glycerin/NMP = 13/6/8/73 | | | |
| composition (wt %) | | | | |
| Inner Dope flow rate | 0.5 | 0.5 | 0.5 | 0.5 |
| (ml/min) | | | | |
| Outer Dope flow | 2 | 2 | 2 | 2 |
| rate (ml/min) | | | | |
| Bore | water | NMP/ | NMP/ | NMP/ |
| composition | | H₂O = | H₂O = | H₂O = |
| (wt %) | | 5/95 | 5/95 | 10/90 |
| Bore flow rate (ml/min) | 3 | 3 | 3 | 3 |
| Air gap (cm) | 20 | 20 | 10 | 20 |
| Take up speed (cm/s) | 6 | 6 | 6 | 6 |

| | |
|---|---|
| External coagulant | Tap water (50 ± 2° C.) |
| (wt %) | |

TABLE 4
Water permeability and MWCO results for
dual layer hollow fiber membranes with
PESU-b-PEGMA in the inner layer

| | Water | |
|---|---|---|
| | permeability | MWCO |
| Membrane ID | (LMH/bar) | (kDa) |
| DL-UF-HF-MM1-2A | 1111 ± 148 | 21 ± 3 |
| DL-UF-HF-MM1-2B | 1701 ± 191 | 27 ± 2 |
| DL-UF-HF-MM1-2C | 1821 ± 298 | 29 ± 3 |
| DL-UF-HF-MM1-2D | 1680 ± 102 | 29 ± 5 |

The DL-UF-HF-MM1-2D membranes have a 52.8±3.1% recovery in its initial water permeability after fouling tests.

### Comparative Example 3

PESU/PESU dual layer hollow fiber membranes without amphiphilic polymer P2 and without PVP in inner layer have been prepared as comparative examples.

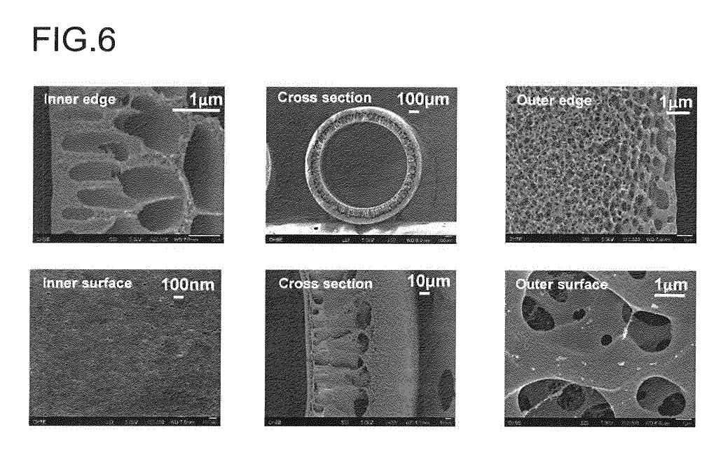

The compositions of the dual-layer ultra filtration hollow fiber (DL-UF-HF) membranes are given in Table 5. Test results obtained with these membranes are given in Table 6. FESEM images are shown in FIG. 6.

TABLE 5
Dope formulations and spinning parameters for PESU/PESU
dual layer hollow fiber membranes with no PVP in inner layer

| Name | DL-UF-HF-STD-1A | DL-UF-HF-STD-1B |
|---|---|---|
| Inner Dope | PESU E3010/ | |
| composition (wt %) | Glycerin/NMP = 16/4/80 | |
| Outer Dope | PESU E3010/PVP K90/ | |
| composition (wt %) | Glycerin/NMP = 13/6/8/73 | |
| Inner Dope flow | 0.5 | 0.5 |
| rate (ml/min) | | |
| Outer Dope flow | 2 | 2 |
| rate (ml/min) | | |
| Bore composition | water | NMP/ |
| (wt %) | | H₂O = |
| | | 10/90 |
| Bore flow rate (ml/min) | 2.5 | 3 |
| Air gap (cm) | 20 | 20 |
| Take up speed (cm/s) | 6 | 6 |

| | |
|---|---|
| External coagulant | Tap water (50 ± 2° C.) |
| (wt %) | |

TABLE 6
Water permeability and MWCO results for
PESU/PESU dual layer hollow fiber
membranes with no PVP in inner layer

| | Water | |
|---|---|---|
| | permeability | MWCO |
| Membrane ID | (LMH/bar) | (kDa) |
| DL-UF-HF-STD-1A | 939 ± 205 | 14 ± 2 |
| DL-UF-HF-STD-1B | 1308 ± 15 | 18 ± 2 |

The DL-UF-HF-STD-1B membranes have a 52.6±5.1% recovery in its initial water permeability after fouling tests.

PESU/PESU dual layer hollow fiber membranes without amphiphilic polymer P2 but with PVP in the inner layer have been prepared as comparative examples.

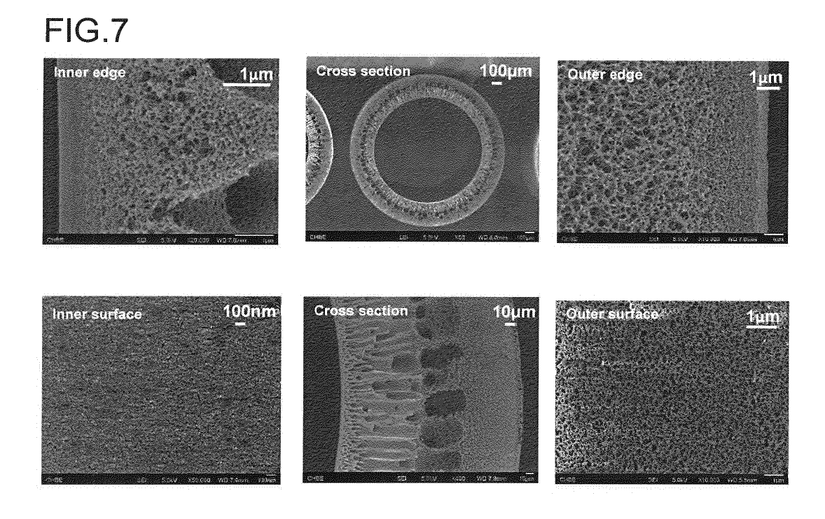

The compositions of the dual-layer ultra filtration hollow fiber (DL-UF-HF) membranes are given in Table 7. Test results obtained with these membranes are given in Table 8. FESEM images are shown in FIG. 7.

TABLE 7
Dope formulations and spinning parameters
for PESU/PESU dual layer hollow fiber
membranes with PVP in inner layer

| | DL-UF-HF- | DL-UF-HF- | DL-UF-HF- |
|---|---|---|---|
| Name | sPPSU-STD-1H | sPPSU-STD-1I | sPPSU-STD-1J |
| Inner Dope | PESU E3010/PVP/ | | |
| composition (wt %) | Glycerin/NMP = 15/2/4/79 | | |
| Outer Dope | PESU E3010/PVP K90/ | | |
| composition (wt %) | Glycerin/NMP = 13/6/8/73 | | |
| Inner Dope flow | 0.5 | 0.5 | 1 |
| rate (ml/min) | | | |
| Outer Dope flow | 2 | 2 | 2 |
| rate (ml/min) | | | |
| Bore composition | water | water | water |
| (wt %) | | | |
| Bore flow | 3.5 | 3.5 | 3.5 |
| rate (ml/min) | | | |
| Air gap (cm) | 20 | 10 | 20 |
| Take up speed (cm/s) | 6 | 6 | 6 |

| | |
|---|---|
| External | Tap water (50 ± 2° C.) 50.7 |
| coagulant (wt %) | |

TABLE 8
Water permeability and MWCO results for
PESU/PESU dual layer hollow fiber
membranes with PVP in inner layer

| | Water | |
|---|---|---|
| | permeability | MWCO |
| Membrane ID | (LMH/bar) | (kDa) |
| DL-UF-HF-sPPSU-STD-1H | 2366 ± 271 | 189 ± 40 |
| DL-UF-HF-sPPSU-STD-1I | 2054 ± 311 | 89 ± 6 |
| DL-UF-HF-sPPSU-STD-1J | 2634 ± 134 | 91 ± 3 |

The DL-UF-HF-sPPSU-STD-1J membranes have a 40.6±3.1% recovery in its initial water permeability after fouling tests.

### Example 4

PSU-PEO-Polysiloxane multiblock copolymers according to the following formula (E4) were applied as amphiphilic polymer P2:

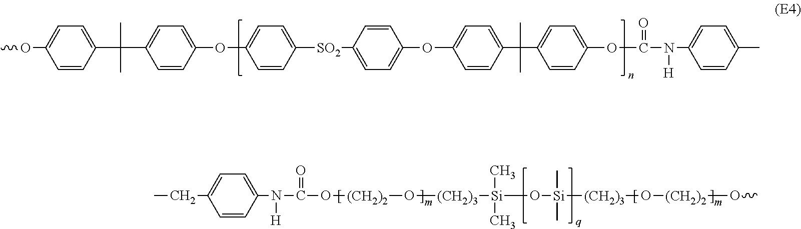

wherein n is 8.5, m is 11.5 and q is 14.1.

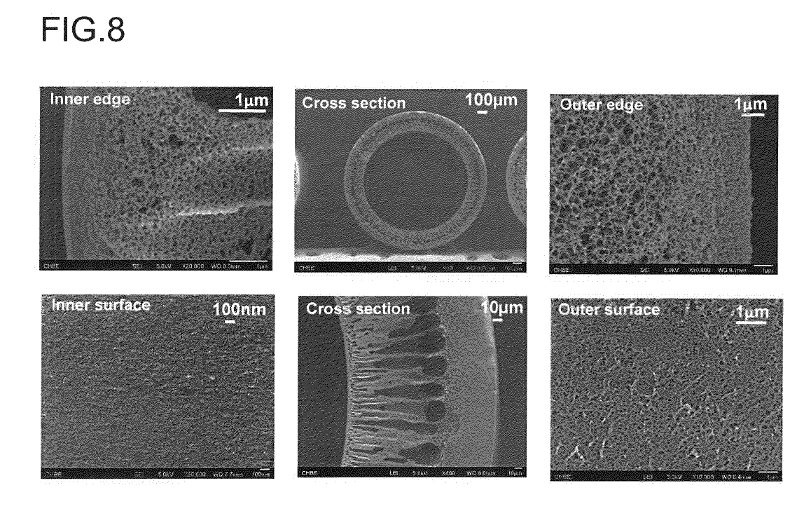

The compositions of the dual-layer ultra filtration hollow fiber (DL-UF-HF) membranes comprising the PSU-PEO-Polysiloxane multiblock copolymer are given in Table 9. Test results obtained with these membranes are given in Table 10. FESEM images are shown in FIG. 8.

TABLE 9
Dope formulations and spinning parameters for dual layer
hollow fiber membranes with PSU-PEO-Polysiloxane
in the inner layer

| | DL-UF-HF- | DL-UF-HF- | DL-UF-HF- | DL-UF-HF- |
|---|---|---|---|---|
| Name | Si-1A | Si-1B | Si-1C | Si-1D |
| Inner Dope composition | PSU-Si/PESU E3010/PVP/ | | | |
| (wt %) | Glycerin/NMP = 2/13/2/4/79 | | | |
| Outer Dope composition | PESU E3010/PVP K90/ | | | |
| (wt %) | Glycerin/NMP = 13/6/8/73 | | | |
| Inner Dope flow rate (ml/min) | 0.5 | 0.5 | 0.5 | 0.5 |
| Outer Dope flow rate (ml/min) | 2 | 2 | 2 | 2 |
| Bore composition (wt %) | water | water | NMP/ | NMP/ |
| | | | water = | water = |
| | | | 10/90 | 10/90 |
| Bore flow rate (ml/min) | 3.5 | 3.5 | 3.5 | 3.5 |
| Air gap (cm) | 20 | 10 | 20 | 10 |
| Take up speed (cm/s) | 6 | 6 | 6 | 6 |

| | |
|---|---|
| External coagulant (wt %) | Tap water (50 ± 2° C.) |

TABLE 10
Water permeability and MWCO results
for dual layer hollow fiber membranes with
PESU-b-PEGMA in the inner layer

| | Water | |
|---|---|---|
| | permeability | MWCO |
| Membrane ID | (LMH/bar) | (kDa) |
| DL-UF-HF-Si-1A | 1219 ± 17 | 83 ± 6 |
| DL-UF-HF-Si-1B | 1675 ± 171 | 181 ± 3 |
| DL-UF-HF-Si-1C | 1617 ± 181 | N.A. |
| DL-UF-HF-Si-1D | 2952 ± 592 | N.A. |

The DL-UF-HF-Si-1A membranes have a 83.0±4.2% recovery in its initial water permeability after fouling tests.

### Example 5

2.5 mol % sulfonated polyphenylenesulfone (sPPSU) copolymers according to the following formula (E5) were applied as amphiphilic polymer P2:

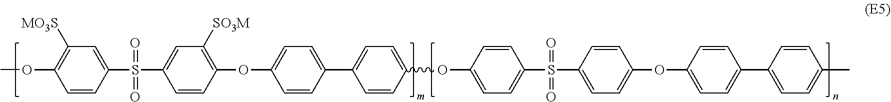

wherein n is 0.975 and m is 0.025 and M is H.

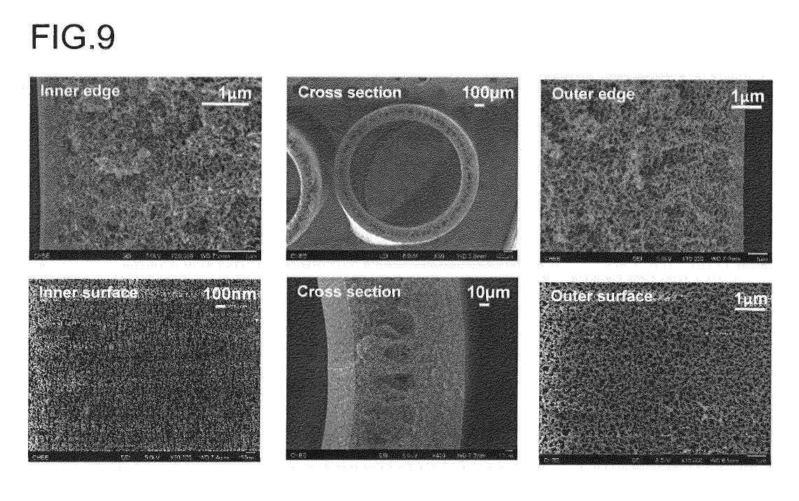

The compositions of the dual-layer ultra filtration hollow fiber (DL-UF-HF) membranes comprising the sPPSU multiblock copolymer are given in Table 11. Test results obtained with these membranes are given in Table 12. FESEM images are shown in FIG. 9.

TABLE 11
Dope formulations and spinning parameters for dual layer hollow fiber membranes 2.5 mol %
sulfonated polyphenylenesulfone (sPPSU) in the inner layer

| | DL-UF-HF- | DL-UF-HF- | DL-UF-HF- | DL-UF-HF- |
|---|---|---|---|---|
| Name | sPPSU-1A | sPPSU-1B | sPPSU-1C | sPPSU-1D |
| Inner Dope | sPPSU/PESU E3010/PVP/Glycerin/NMP = 13/2/2/4/79 | | | |
| composition (wt %) | | | | |
| Outer Dope | PESU E3010/PVP K90/Glycerin/NMP = 13/6/8/73 | | | |
| composition (wt %) | | | | |
| Inner Dope flow | 0.5 | 1 | 0.5 | 1 |
| rate (ml/min) | | | | |
| Outer Dope flow | 2 | 2 | 2 | 2 |
| rate (ml/min) | | | | |
| Bore composition | water | water | NMP/ | NMP/ |
| (wt %) | | | H₂O = | H₂O = |
| | | | 10/90 | 10/90 |
| Bore flow rate (ml/min) | 3.5 | 3.5 | 3.5 | 3.5 |
| Air gap (cm) | 20 | 20 | 20 | 20 |
| Take up speed (cm/s) | 6 | 6 | 6 | 6 |

| | |
|---|---|
| External coagulant (wt %) | Tap water (50 ± 2° C.) |

TABLE 12
Water permeability and MWCO results
for dual layer hollow fiber membranes
with 2.5 mol % sulfonated
polyphenylenesulfone (sPPSU) in
the inner layer

| | Water | |
|---|---|---|
| | permeability | MWCO |
| Membrane ID | (LMH/bar) | (kDa) |
| DL-UF-HF-sPPSU-1A | 745 ± 58 | 49 ± 6 |
| DL-UF-HF-sPPSU-1B | 646 ± 114 | 36 ± 9 |
| DL-UF-HF-sPPSU-1C | 823 ± 114 | 71 ± 9 |
| DL-UF-HF-sPPSU-1D | 563 ± 23 | 31 ± 1 |

The DL-UF-HF-sPPSU-1C membranes have a 95.8±0% recovery in its initial water permeability after fouling tests.

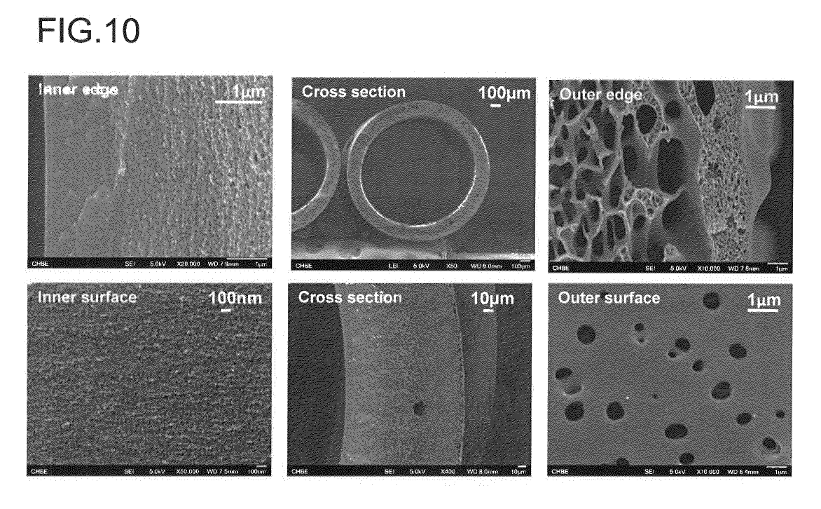

The compositions of the dual-layer ultra filtration hollow fiber (DL-UF-HF) membranes comprising the sPPSU copolymer having a high dope concentration are given in Table 13. Test results obtained with these membranes are given in Table 14. FESEM images are shown in FIG. 10.

TABLE 13
Dope formulations and spinning parameters for dual layer hollow fiber membranes 2.5 mol %
sulfonated polyphenylenesulfone (sPPSU) in the inner layer (higher dope concentration)

| | DL-UF-HF- | DL-UF-HF- | DL-UF-HF- | DL-UF-HF- |
|---|---|---|---|---|
| Name | sPPSU-2A | sPPSU-2B | sPPSU-20 | sPPSU-2D |
| Inner Dope | sPPSU/PESU E3010/PVP/Glycerin/NMP = 14/3/3/4/76 | | | |
| composition (wt %) | | | | |
| Outer Dope | PESU E3010/PVP K90/Glycerin/NMP = 19/6/10/65 | | | |
| composition (wt %) | | | | |
| Inner Dope flow | 0.5 | 0.3 | 0.3 | 0.15 |
| rate (ml/min) | | | | |
| Outer Dope flow rate | 2 | 2 | 2 | 2 |
| (ml/min) | | | | |
| Bore composition | NMP/ | NMP/ | NMP/ | NMP/ |
| (wt %) | water = | water = | water = | water = |
| | 10/90 | 10/90 | 10/90 | 10/90 |
| Bore flow rate (ml/min) | 3.5 | 3.5 | 3.5 | 3.5 |
| Air gap (cm) | 20 | 20 | 10 | 20 |
| Take up speed (cm/s) | 6 | 4 | 4 | 3 |

| | |
|---|---|
| External coagulant (wt %) | Tap water (50 ± 2° C.) |

TABLE 14
Water permeability and MWCO results
for dual layer hollow fiber membranes
with 2.5 mol % sulfonated
polyphenylenesulfone (sPPSU) in the
inner layer (higher dope concentration)

| | Water | |
|---|---|---|
| | permeability | MWCO |
| Membrane ID | (LMH/bar) | (kDa) |
| DL-UF-HF-sPPSU-2A | 790 ± 58 | 100 ± 24 |
| DL-UF-HF-sPPSU-2B | 847 ± 90 | 87 ± 12 |
| DL-UF-HF-sPPSU-2C | 1100 ± 177 | N.A |

| | |
|---|---|
| DL-UF-HF-sPPSU-2D | delaminated |

The DL-UF-HF-sPPSU-2A and DL-UF-HF-sPPSU-2B membranes have a 100% and 97.4±5.4% recovery in its initial water permeability after fouling tests, respectively.

### REFERENCE NUMERAL LIST

10 multilayer single-bore hollow fibre membrane M
12 substrate S (support) (polymer P1)
13 surface (of 12)
14 functional layer F (polymer P2)
16 bore (free cross-section)
18 flow direction
20 multilayer multi-bore hollow fibre membrane M
30 spinneret (dual-layer)
32 flow of polymer 1
34 flow of polymer 2
36 bore fluid (third material)
38 precipitation bath
40 functional material
(hydrophilic, isoporous properties)

1. A multilayer single-bore hollow fibre membrane M or multilayer multi-bore hollow fibre membrane M for ultrafiltration applications, comprising at least one hollow fibre membrane substrate S comprising a polymer bulk material P1 and at least one functional layer F disposed on at least the inner surface of the hollow fibre membrane substrate S, wherein the functional layer F comprises at least one amphiphilic polymer P2.

2. The multilayer single-bore hollow fibre membrane M or multilayer multi-bore hollow fibre membrane M for ultrafiltration applications according to claim 1, wherein the at least one amphiphilic polymer P2 is selected from the group consisting of the following amphiphilic block copolymers P2.1, P2.2, P2.3, P2.4 and P2.5 or mixtures thereof:
P2.1 is an amphiphilic polyethersulfone block copolymer comprising at least one hydrophobic block unit (A) and at least one hydrophilic block unit (B) of the following general formulae: 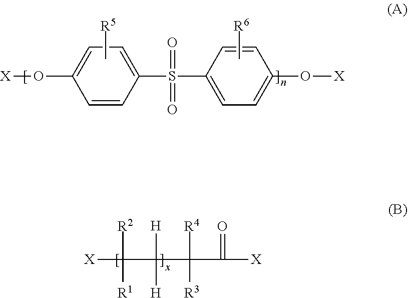
wherein
R¹ is —CO(O-alkylene)ₘ—OR⁷, —CO(O-alkylene)ₘ—SO₃⁻M⁺, —CO(O-alkylene)ₘ—NR⁸R⁹R¹⁰ , —CO—Z—N—R⁸R⁹, —CO(O-alkylene)ₘ—NHR⁸, —CO(O-alkylene)ₘ—N⁺R⁸R⁹R¹¹W⁻, or optionally substituted N-heterocyclyl (e.g. N-pyrrolidonyl);
R² is hydrogen, halogen, optionally substituted alkyl (e.g. methyl), perfluorinated alkyl, optionally substituted aryl, cyano, nitro, amino, or heterocyclyl;
R³, R⁴ independently are hydrogen, halogen, optionally substituted alkyl (e.g. methyl), perfluorinated alkyl, optionally substituted aryl, cyano, nitro, amino, or heterocyclyl;
R⁵, R⁶ independently are hydrogen, halogen, or a sulfonic acid group;
n is an integer in a range from 5 to 80;
m, x independently are integer in a range from 1 to 20;
R⁷ is hydrogen, alkyl, or alkoxy-alkyl;
R⁸, R⁹ independently are hydrogen, optionally substituted alkyl;
R¹⁰ is alkylene-SO₃H or alkylene-SO₃⁻M⁺;
R¹¹ is hydrogen, alkyl, aryl-alkyl;
Z is alkylene or a chemical bond;
X is hydrogen or another block unit (B) in which X, x, and R¹ to R⁴ are as defined above;
W is halogen, OTf, BF₄, BPh, PF₆ or SbF₆;
M is alkaline metal (Na, K, Li) or alkaline earth metal (e.g. Ca, Mg);
P2.2 is an amphiphilic partially sulfonated poly(arylene ether sulfone) copolymer comprising at least one unit (C) and at least one unit (D) of the following general formulae: 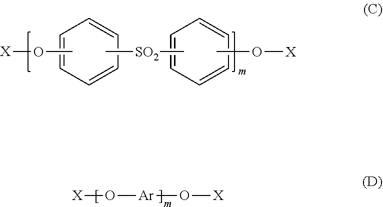
wherein
Ar represents a divalent arylene residue;
m, n are independently integer in a range from 1 to 80;
X each independently represents a hydrogen atom, an alkyl group, a block unit (C) or a block unit (D);
at least one monomeric unit selected from (C) and (D) is sulfonated; and
the aromatic rings of (C) and/or (D) may further carry one or more same or different substituents (different from sulfo residues of the type —SO₃H, or the corresponding metal salt form thereof of the type —SO₃⁻M⁺);
P2.3 is an amphiphilic polystyrene block copolymer comprising at least one hydrophobic block unit (E) and at least one hydrophilic block unit (F) of the following general formulae: 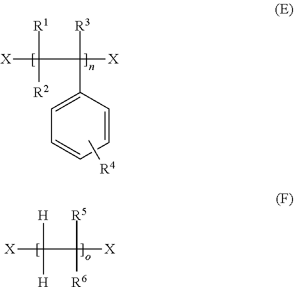
wherein
R¹, R² independently are hydrogen, halogen, optionally substituted alkyl, perfluorinated alkyl, optionally substituted aryl, cyano, nitro, amino, or heterocyclyl;
R³ is hydrogen, an optionally substituted alkyl having 1 to 18 carbon atoms or an aryl, optionally substituted with 1 to 5;
R⁴ is hydrogen, halogen or a sulfonic acid group;
R⁵ is —CO(O-alkylene)ₘ—OR⁷, —CO(O-alkylene)ₘ—SO₃⁻M⁺, —CO(O-alkylene)ₘ—NR⁸R⁹R¹⁰, —CO(O-alkylene)ₘ—NHR⁸, —CO(O-alkylene)ₘ—N⁺R⁸R⁹R¹¹W⁻;
R⁶ is hydrogen, an optionally substituted alkyl having 1 to 18 carbon atoms or an aryl, optionally substituted with 1 to 5 substituent selected from a hydrogen, halogen or a sulfonic acid group;
X each independently represents a hydrogen atom, an alkyl group, a block unit (E) or a block unit (F);
n, o independently are integer in a range from 20 to 80;
m is an integer in a range from 1 to 20;
R⁷ is hydrogen, alkyl, or alkoxy-alkyl;
R⁸, R⁹ independently are hydrogen, optionally substituted alkyl;
R¹⁰ is alkylene-SO₃⁻;
R¹¹ is hydrogen, alkyl, aryl-alkyl;
W is halogen, OTf, BF₄, BPh, PF₆ or SbF₆;
M is alkaline metal (Na, K, Li) or alkaline earth metal;
P2.4 is an amphiphilic polystyrene block-copolymer comprising at least one hydrophobic block unit (G) and at least one hydrophilic block unit (H) of the following general formulae: 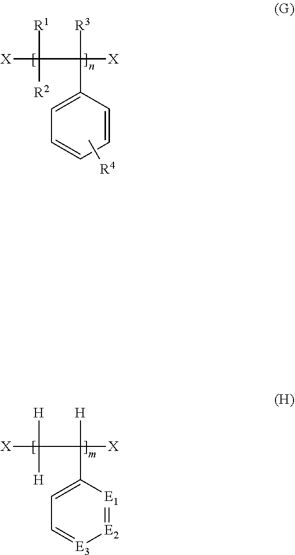
wherein
R¹, R² independently are hydrogen, halogen, optionally substituted, perfluorinated alkyl, optionally substituted aryl, cyano, nitro, amino, or heterocyclyl;
R³ is hydrogen, an optionally substituted alkyl having 1 to 18 carbon atoms or an aryl, optionally substituted with 1 to 5 substituent selected from a hydrogen, halogen or a sulfonic acid group;
R⁴ is hydrogen, halogen or a sulfonic acid group;
X each independently represents a hydrogen atom, an alkyl group, a block unit (G) or a block unit (H);
n, m independently are integer in a range from 20 to 80; and
E¹, E², and E³ represent a carbon atom or a nitrogen atom, with the proviso that if one of E¹, E², or E³ represents a nitrogen atom, the other two represent a carbon atom; and
P2.5 is an amphiphilic poly(arylene ether sulfone) block copolymer comprising at least one hydrophilic block unit (I) and at least one hydrophobic block unit (J) of the following general formulae: 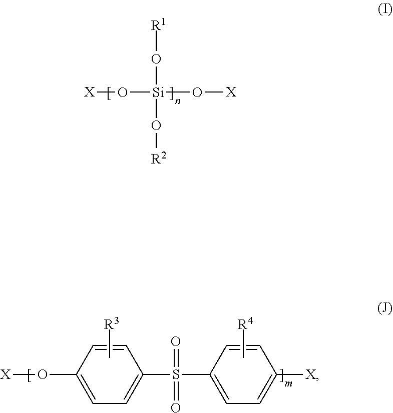
wherein
R¹, R² independently are linear, branched or cyclic alkyls having 1 to 18 carbon atoms, a further block unit (I) or a block unit (J);
R⁵, R⁶ independently are hydrogen, halogen, or a sulfonic acid group;
X each independently represents a hydrogen atom, an alkyl group, a repeating unit (I) or a repeating unit (J);
n is an integer in a range from 1 to 10,
m is an integer in a range from 5 to 80.

3. The multilayer single-bore hollow fibre membrane M or multilayer multi-bore hollow fibre membrane M for ultrafiltration applications according to claim 1, wherein the functional layer F comprises a mixture of the at least one amphiphilic polymer P2 and at least one bulk polymer P1.

4. The multilayer single-bore hollow fibre membrane M or multilayer multi-bore hollow fibre membrane M for ultrafiltration applications according to claim 1, wherein wherein the polymer bulk material P1 is selected from the group consisting of polyethersulfone (PESU), sulfonated polyethersulfone, polysulfone (PSU), sulfonated polysulfone, polyphenylsulfone (PPSU), sulfonated polyphenylsulfone, polyacrylonitrile (PAN), polyvinylidenefluoride (PVDF), cellulose acetate (CA), polyamide (PA), polyethylene (PE), polypropylene (PP), polyester (PES), polyimide (PI), cellulose esters (CE), polytetrafluoroethylene (PTFE), polyvinylchloride (PVC) and blends thereof.

5. The multilayer single-bore hollow fibre membrane M or multilayer multi-bore hollow fibre membrane M for ultrafiltration applications according to claim 1, wherein the functional layer F which is applied to the inner surface of the substrate S has a thickness of 1 to 20 of the thickness of the hollow fibre membrane substrate S to which the functional layer F is applied.

6. The multilayer single-bore hollow fibre membrane M or multilayer multi-bore hollow fibre membrane M for ultrafiltration applications according to claim 1, wherein the functional layer F has a thickness from 5 to 600 μm.

7. The multilayer multi-bore hollow fibre membrane M for ultrafiltration applications according to claim 1, comprising a substrate S with a circular cross-section having from 2 to 15, bores arranged therein, wherein the functional layer F is applied to at least one inner surface of one bore of the multi-bore hollow fibre membrane M.

8. The multilayer single-bore hollow fibre membrane M or multilayer multi-bore hollow fibre membrane M for ultrafiltration applications according to claim 1, wherein the polymeric bulk material P1 essentially consists of polyethersulfone (PESU) and the amphiphilic polymer P2 essentially consists of an amphiphilic polyethersulfone block copolymer P2.1.

9. The multilayer single-bore hollow fibre membrane M or multilayer multi-bore hollow fibre membrane M for ultrafiltration applications according to claim 1, wherein the polymeric bulk material P1 essentially consists of polyethersulfone (PESU) and the amphiphilic polymer P2 essentially consists of an amphiphilic partially sulfonated poly(arylene ether sulfone) copolymer P2.2.

10. The multilayer single-bore hollow fibre membrane M or multilayer multi-bore hollow fibre membrane M for ultrafiltration applications according to claim 1, wherein the polymeric bulk material P1 essentially consists of polyethersulfone (PESU) and the amphiphilic polymer P2 essentially consists of an amphiphilic polystyrene block-copolymer P2.3.

11. The multilayer single-bore hollow fibre membrane M or multilayer multi-bore hollow fibre membrane M for ultrafiltration applications according to claim 1, wherein the polymeric bulk material P1 essentially consists of polyethersulfone (PESU) and the amphiphilic polymer P2 essentially consists of an amphiphilic polystyrene block-copolymer P2.4.

12. The multilayer single-bore hollow fibre membrane M or multilayer multi-bore hollow fibre membrane M for ultrafiltration applications according to claim 1, wherein the polymeric bulk material P1 essentially consists of polyethersulfone (PESU) and the amphiphilic polymer P2 essentially consists of poly(arylene ether sulfone) block-copolymer P2.5.

13. An ultrafiltration method, comprising filtering a substance with the multilayer single-bore hollow fibre membrane M or multilayer multi-bore hollow fibre membrane M according to claim 1.

14. A filtration module, comprising the multilayer single-bore hollow fibre membrane M or multilayer multi-bore hollow fibre membrane M according to claim 1.

15. The filtration module according to claim 14, which is adapted to function as a filtration module for hemodialysis, protein separation/fractionation, virus removal, recovery of vaccines and antibiotics from fermentation broths, wastewater treatment, milk/dairy product concentration, or concentration of fruit juice.

16. The filtration module according to claim 14, wherein the filtration module is an ultrafiltration module.
